(19) United States
(12) Patent Application Publication
(10) Pub. No.: US 2012/0215463 A1
(43) Pub. Date: Aug. 23, 2012

(54) Rapid Genomic Sequence Homology Assessment Scheme Based on Combinatorial-Analytic Concepts

(75) Inventor: Andrzej K. Brodzik, Jamaica Plain, MA (US)

(73) Assignee: The MITRE Corporation, McLean, VA (US)

(21) Appl. No.: 13/033,226

(22) Filed: Feb. 23, 2011

(51) Int. Cl. G06F 19/00

(52) U.S. Cl. 702/20

(57) ABSTRACT

The present invention relates to methods and apparatus for rapid assessment of genomic sequences using the difference set model. The invention provides methods to determine the presence and identity of similarities and differences in genomic sequences. In particular, the invention provides methods and apparatus to assess homology, the presence and identity of insertion and deletion segments and the presence and identity of single nucleotide polymorphisms in genomic sequences.

### BACKGROUND OF THE INVENTION

1. Field of the Invention

The present invention relates to methods and apparatus for rapid assessment of genomic sequences using the difference set model. The invention provides methods to determine the presence and identity of similarities and differences in genomic sequences.

2. Background Art

In the area of genetic research, the first step following the sequencing of a new gene or genome is an effort to identify the gene or genome identity and/or function. The most popular and straightforward methods to achieve that goal exploit the fact that if two peptide stretches exhibit sufficient similarity at the sequence level (i.e., one can be obtained from the other by a small number of insertions, deletions and/or amino acid mutations), then they probably are biologically related. Examples of such an approach are described in A. M. Lesk, “Computational Molecular Biology,” Encyclopedia of Computer Science and Technology; A. Kent and J. G. Williams editors 31, 101-165, Marcel Dekker, New York, 1994; R. F. Doolittle, “What we have learned and will learn from sequence databases,” Computers and DNA, G. Bell and T. Marr editors, 21-31, Addison-Wesley, 1990; C. Caskey, R. Eisenberg, E. Lander, and J. Straus, “Hugo statement on patenting of DNA,” Genome Digest 2:6-9, 1995; and W. R. Pearson, “Protein sequence comparison and protein evolution,” Tutorial of Intelligent Systems in Molecular Biology, Cambridge, England, 1995. Comparing sequences to determine similarities is also useful in a variety of different contexts, for example, identifying an unknown microbe in a metagenomic sample, identifying or matching human DNA, tree of life investigations and monitoring synthetic DNA requests.

Within this framework, determining the function of a putative new gene, or the identity of a gene or genome, for example, can be facilitated by identifying homologies in strings of amino acids. Thus, given a query sequence (e.g., the putative new gene or unknown gene or genome) and a set of well characterized proteins, a comparison is made to identify regions of the query sequence that are similar to regions of sequences in the set of well characterized proteins.

The first approaches used for realizing this task were based on a technique known as dynamic programming. This approach is described in S. B. Needleman and C. D. Wunsch, “A General Method Applicable To The Search For Similarities In The Amino Acid Sequence Of Two Proteins,” Journal Of Molecular Biology 48:443-453 (1970); and T. F. Smith and M. S. Waterman, “Identification Of Common Molecular Subsequences,” Journal Of Molecular Biology 147:195-197 (1981). Unfortunately, the computational requirements of this method quickly render it impractical, especially when searching large databases, as is the norm today. Generally, the problem is that dynamic programming variants spend a good part of their time computing homologies that eventually turn out to be unimportant.

In an effort to work around this issue, a number of algorithms have been proposed which focus on discovering only extensive local similarities. The most well known among these algorithms are referred to as FASTA and BLAST. The FASTA algorithm is described in W. R. Pearson, and D. J. Lipman, “Improved tools for biological sequence comparison,” Proc. Natl. Acad. Sci. 85:2444-2448 (1988); and D. J. Lipman, and W. R. Pearson, “Rapid and sensitive protein similarity searches,” Science 227:1435-1441 (1989). The BLAST algorithm is described in S. Altschul, et al. “A basic local alignment search tool,” J. Mol. Biology 215:403-410 (1990). In the majority of the cases, increased performance is achieved by first looking for ungapped homologies, i.e., similarities due exclusively to mutations and not insertions or deletions. The rationale behind this approach is that in any substantial gapped homology between two peptide strings, chances are that there exists at least a pair of substrings whose match contains no gaps. The locating of these substrings (the ungapped homology) can then be used as the first step towards obtaining the entire (gapped) homology.

Identifying the similar regions between the query and the database sequences is, however, only the first part of the process. The second part, the one that is of interest to biologists, is evaluating these similarities, i.e., deciding if they are substantial enough to sustain the inferred relation (functional, structural or otherwise) between the query and the corresponding data base sequence(s). Such evaluations are often performed by combining biological information and statistical reasoning. Typically, similarity is quantified as a score computed for every pair of related regions. Computation of this score involves the use of gap costs, for gapped alignments, and of appropriate mutation matrices giving the evolutionary probability of any given amino acid changing into another. Examples of these matrices are the PAM matrix (see M. O. Dayhoff, R. M. Schwartz and B. C. Orcutt, “A model of evolutionary change in proteins,” Atlas of Protein Sequence and Structure 5:345-352 (1978)) and the BLOSUM matrix (see S. Henikoff and J. G. Henikoff, “Amino acid substitution matrices from protein blocks,” Proc. Natl. Acad. Sci. 89:915-919, (1992)). Then, the statistical importance of this cost is evaluated by computing the probability, under some statistical model, that such a score could arise purely by chance, e.g., see S. Karlin, et al., “Statistical composition of high-scoring segments from molecular sequences,” The Annals of Statistics 2:571-581 (1990); and S. Karlin and S. Altschul, “Methods for assessing the statistical significance of molecular sequence features by using general scoring schemes,” Proc. Natl. Acad. Sci. 87:2264-2268 (1990). Depending on the statistical model used, this probability can depend on a number of factors such as the length of the query sequence, the size of the underlying database, etc. No matter, however, what conventional statistical model one uses there are always the so called “gray areas,” i.e., situations where a statistically unimportant score indicates really a biologically important similarity. Unfortunate as this might be, it is also inescapable; there is after all a limit to how well a statistical model can approximate the biological reality.

An alternative to the inherent difficulty of attaching statistical importance to weak similarities is the use of biological knowledge in deducing sequence descriptors that model evolutionary distant homologies. BLOCKS (see S. Henikoff and J. Henikoff, “Automatic Assembly of Protein Blocks for Database Searching,” Nucleic Acids Research 19:6565-6572 (1991)) is a system that employs pattern-induced profiles obtained over the protein classification defined in the PROSITE (see S. Henikoff and J. Henikoff, “Protein Family Classification Based on Searching a Database of Blocks,” Genomics 19:97-107, (1994)) database in order to functionally annotate new genes. The advantage of these approaches is that this classification is compiled by experts working with families of proteins known to be related. As a result, even weak similarities can be recognized and used in the annotation process. On the other hand, such methods are limited by the knowledge of protein families. Further, there is always the danger that a family of proteins actually contains more members than currently identified. By excluding these other members from consideration, it is possible to get patterns that “over fit” the family, i.e., they are too strict to extrapolate to the unidentified family members.

In an effort to overcome the disadvantages of detection of homology using alignment of sequences, alignment-free sequence homology evaluation has been considered previously in many works, including M. Bauer et al., “The average mutual information profile as a genomic signature,” BMC Bioinformatics 9:1-11 (2008), Chang, P. et al., “Structure alignment based on coding of local geometric measures,” BMC Bioinformatics 7:1-10 (2006), Q. Dai and T. Wang, “Comparison study on k-word statistical measures for protein: From sequence to sequence space,” BMC Bioinformatics 9(6):1-19 (2008), Ferragina, P. et al., “Compression-based classification of biological sequences and structures via the universal similarity metric: Experimental assessment,” BMC Bioinformatics 8:1-20 (2007), Hochreiter, S. et al., “Fast model based protein homology detection without alignment,” Bioinformatics 23(14):1728-1736 (2007), Lingner, T. and Meinicke, P., “Remote homology detection based on oligomer distances,” Bioinformatics 22(18):2224-2231 (2006), and Rausch, T. et al., “Segment based multiple sequence alignment,” Bioinformatics 24:187-192 (2008). A useful review of earlier research in this area is given in Ving a, S., “Alignment-free sequence comparison—A review,” Bioinformatics 19(4):513-523 (2003). These techniques can be divided into two main categories: 1) methods based on word frequency and 2) methods that do not involve counting segments of fixed length. Methods in the first category utilize statistics of word frequency to identify homologous regions in sequences and frequency vectors to compute a distance between these sequences. Methods in the second category are more diverse. They seek sequence representations that are scale independent and utilize distance measures rooted in Shannon information theory, Kolmogorov complexity theory, or chaos theory. Most of these methods focus on protein sequence similarity. These methods also have disadvantages. For example, the number of computations can be significant, leading to prohibitively high computational costs.

A need therefore exists for fast and accurate computational methods of evaluating similarities and differences between genomic sequences.

### BRIEF SUMMARY OF THE INVENTION

In embodiments, the present invention provides a computer-based method of detecting homology between at least one reference sequence and at least one query sequence. As illustrated in FIG. 12, in embodiments, the method comprises creating at least one query sub-sequence from the query sequence; determining the locations of at least one difference set in the query sub-sequence; comparing the locations of the difference set in the query sub-sequence to locations of the difference set in a reference sub-sequence; and generating a global homology score, wherein the global homology score represents a degree of homology between the reference sequence and the query sequence, wherein each of the steps in the method are performed on a suitably programmed computer.

In further embodiments, the present invention further provides a computer-based method of determining the presence of an insertion sequence, a deletion sequence, or a combination thereof, in at least one query sequence as compared to at least one reference sequence. As illustrated in FIG. 13, in embodiments of the invention, the method comprises determining a distribution of at least one difference set in a query sub-sequence; comparing the distribution of the difference set in the query sub-sequence with a distribution of the difference set in a sub-sequence of the reference sequence; and identifying a portion of the query sub-sequence that is not homologous with the reference subsequence, wherein the non-homologous portion indicates the presence of an insertion sequence, a deletion sequence, or both, wherein each step in the method is performed on a suitably programmed computer.

The invention further provides computer-based method of identifying at least one single nucleotide polymorphism in at least one query sequence as compared to at least one reference sequence. As illustrated in FIG. 14, in embodiments, the method comprises determining a distribution of at least one difference set in a query sub-sequence; comparing the distribution of the difference set in the query sub-sequence with a distribution of the difference set in a sub-sequence of the reference sequence; removing regions of sequence in the query sub-sequence or the reference sub-sequence, or both, that contain insertion sequences, deletion sequences, or both, to create modified sub-sequences; and identifying single nucleotide polymorphisms in the modified sub-sequences from the previous step; wherein each step in the method is performed on a suitably programmed computer.

In additional embodiments, the invention provides an apparatus for detecting homology between at least one reference sequence and at least one query sequence. In embodiments, the apparatus comprises at least one processor operative to: create at least one query sub-sequence from the query sequence; determine the locations of at least one difference set in the query sub-sequence; compare the locations of the difference set in the query sub-sequence to locations of the difference set in a reference sub-sequence; and generate a global homology score, wherein the global homology score represents a degree of homology between the reference sequence and the query sequence.

In further embodiments, the invention provides an article of manufacture for detecting homology between at least one reference sequence and at least one query sequence, comprising a machine readable medium containing one or more programs which when executed implement the steps of: creating at least one query sub-sequence from the query sequence; determining the locations of at least one difference set in the query sub-sequence; comparing the locations of the difference set in the query sub-sequence to locations of the difference set in a reference sub-sequence; and generating a global homology score, wherein the global homology score represents a degree of homology between the reference sequence and the query sequence.

In further embodiments, the invention provides an apparatus for determining the presence of an insertion sequence, a deletion sequence, or a combination thereof, in at least one query sequence as compared to at least one reference sequence. In embodiments of the invention, the apparatus comprises at least one processor operative to determine a distribution of at least one difference set in a query sub-sequence; compare the distribution of the difference set in the query sub-sequence with a distribution of the difference set in a sub-sequence of the reference sequence; and identify a portion of the query sub-sequence that is not homologous with the reference subsequence, wherein the non-homologous portion indicates the presence of an insertion sequence, a deletion sequence, or both.

In additional embodiments, the invention provides an article of manufacture for determining the presence of an insertion sequence, a deletion sequence, or a combination thereof, in at least one query sequence as compared to at least one reference sequence, comprising a machine readable medium containing one or more programs which when executed implement the steps of: determining a distribution of at least one difference set in a query sub-sequence; comparing the distribution of the difference set in the query sub-sequence with a distribution of the difference set in a sub-sequence of the reference sequence; and identifying a portion of the query sub-sequence that is not homologous with the reference subsequence, wherein the non-homologous portion indicates the presence of an insertion sequence, a deletion sequence, or both.

In further embodiments, the invention provides an apparatus for identifying at least one single nucleotide polymorphism in at least one query sequence as compared to at least one reference sequence. In embodiments of the invention, the apparatus comprises at least one processor operative to determine a distribution of at least one difference set in a query sub-sequence; compare the distribution of the difference set in the query sub-sequence with a distribution of the difference set in a sub-sequence of the reference sequence; remove regions of sequence in the query sub-sequence or the reference sequence, or both, that contain insertion sequences, deletion sequences, or both, to create modified sub-sequences; and identify single nucleotide polymorphisms in the modified sub-sequences from the previous step.

In additional embodiments, the invention provides an article of manufacture for identifying at least one single nucleotide polymorphism in at least one query sequence as compared to at least one reference sequence, comprising a machine readable medium containing one or more programs which when executed implement the steps of: determining a distribution of at least one difference set in a query sub-sequence; comparing the distribution of the difference set in the query sub-sequence with a distribution of the difference set in a sub-sequence of the reference sequence; removing regions of sequence in the query sub-sequence or the reference sequence, or both, that contain insertion sequences, deletion sequences, or both, to create modified sub-sequences; and identifying single nucleotide polymorphisms in the modified sub-sequences from the previous step.

The inventive concepts described herein may be implemented on a network such as, for example, the Internet, in a client-server relationship. Network implementation of the methods of the invention allows a user to enter a query sequence at a client device at a remote location that is transmitted to a server over the network and processed at the server. The server then returns the results of the homology evaluation to the client device of the user via the network.

These and other objects, features and advantages of the present invention will become apparent from the following detailed description of illustrative embodiments thereof, which is to be read in connection with the accompanying drawings.

### BRIEF DESCRIPTION OF THE DRAWINGS/FIGURES

FIG. 1 is an example of two barcodes illustrating the distribution of difference sets in two subsequences. The distribution of difference sets (7, 3, 1) in the first 10,000 bases of the Ames Ancestor (top) and Pasteur (bottom) pXO2 ‘A’ subsequence is shown.

FIG. 2 is an example of two barcodes illustrating the distribution of difference sets in two subsequences. The distribution of difference sets (7, 3, 1) in a segment of the Ames Ancestor (top) and Sterne (bottom) pXO1 ‘C’ subsequences, located between 40,000 and 50,000 bp is shown.

FIG. 3 shows the distribution of difference sets (7, 3, 1) in two 10,000-point random binary sequences with 24% 1-content.

FIG. 4 is an example of two barcodes illustrating the distribution of difference sets in two subsequences. The distribution of difference sets (7, 3, 1) in the Ames Ancestor (top) and Sterne (bottom) pXO1 ‘C’ subsequence is shown.

FIG. 5 shows the difference set sequences associated with the pXO1 plasmid: Ames Ancestor (top), Sterne (middle), cross-correlation sequence (bottom).

FIG. 6 shows three matching segments of the pXO1 sequences obtained by matching the entire sequences at shifts given by the three largest values of the cross-correlation sequence in FIG. 5.

FIG. 7 is a plot of SNP number versus nucleotide number, showing the distribution of SNPs in chromosomal sequences of the B. anthracis genome (A-S). Blue dots mark AA-S SNPs, red asterisks mark AA-A SNPs.

FIG. 8 is a plot of SNP number versus nucleotide number, showing the distribution of nsSNPs in chromosomal sequences of the B. anthracis genome (A-S). Blue dots mark AA-S SNPs, red asterisks mark AA-A SNPs.

FIG. 9 is a histogram of SNPs in the B. anthracis chromosome, strains AA-A-S.

FIG. 10 is a block diagram of an exemplary hardware implementation of a rapid genomic sequence assessment system of the present invention.

FIG. 11 is a block diagram of a network-based implementation of a rapid genomic sequence assessment of the present invention.

FIG. 12 is a flow chart illustrating a homology detection method according to an embodiment of the invention.

FIG. 13 is a flow chart illustrating an insertion or deletion sequence detection and identification method according to an embodiment of the invention.

FIG. 14 is a flow chart illustrating a single nucleotide polymorphism detection and identification method according to an embodiment of the invention.

### DETAILED DESCRIPTION OF THE INVENTION

### Introduction

A detailed description of the invention is presented in this section, the organization of which is as follows. In the first section titled “Definitions,” specific words and phrases used herein are defined. The Definitions section is followed by the “Overview of the Invention,” which cites the advantages of the invention and providing a summary of the general methods and apparatus of the invention.

Three separate sections follow the Overview of the Invention, disclosing: (a) methods of the invention relating to assessing homology, (b) methods of the invention relating to determining insertion/deletion sequences, and (c) methods of the invention relating to determining single nucleotide polymorphisms.

The next section, “The Difference Set Model,” is a detailed description of the difference set model, which, in embodiments, is used to implement the methods of the invention. The section regarding difference sets has the following sub-sections: (1) Introduction, (2) DNA Symbol Representation, and (3) Cyclic Difference Sets.

In embodiments, the methods of the invention use phase-only Fourier cross correlation to compare sequence information. The “Phase-only Fourier Cross-Correlation” section provides a detailed description of this method.

The difference set model is exemplified and applied to bacterial strains in the section titled “Application of Difference Sets.” This section includes a subsection titled, “Detection of SNPs” that exemplifies the detection of single nucleotide polymorphisms in bacterial strains.

In embodiments of the invention, for some more complicated tasks a more complex model than the difference set model is needed. Accordingly, the next section titled “Beyond Difference Sets” discloses a detailed description of mathematical models that can be applied in the methods of the invention. The Conclusion, which briefly summarizes the difference set model follows.

The methods of the invention are implemented using a computer, and the section of the detailed description titled “Computer Implementation” discloses exemplary hardware components of the invention, and components used to implement the methods of the invention.

### DEFINITIONS

As used herein, the term “sequence” or “genomic sequence” means a series of symbolic characters. The symbolic characters in a sequence represent chemical entities. For example, if the sequence represents a DNA sequence, the symbolic characters in the reference sequence, e.g., A, G, C, and T represent the nucleotide bases, adenine, guanine, cytosine and thymine. If the sequence is a polypeptide sequence, the symbolic characters represent amino acids, e.g., tyrosine, guanine, phenylalanine, etc.

As used herein, the term “reference sequence” means a series of symbolic characters that another sequence is being compared to. In some embodiments of the invention, the reference sequence is known, i.e., both the order and identity of the building blocks of the sequence are known. In other embodiments of the invention, the reference sequence is partially known, e.g., only a portion of the sequence has been identified.

In further embodiments of the invention, the reference sequence has been identified as having a particular function, e.g., the reference sequence is a DNA sequence that has been identified as encoding a protein for which the function is known. The reference sequence may also be the sequence of the genome of an organism, e.g., a bacteria. In such cases, the reference sequence can be in a database that contains the location and identity of the building blocks of the sequence in addition to the function of the particular sequence. For example, a reference sequence may be identified as the DNA sequence for a plasmid associated with a particular bacterial strain; or a reference sequence may be an amino acid sequence that has been identified as a protein having a particular function. In yet another example, a reference sequence may be an RNA sequence that is known to code for a specific DNA sequence during transcription. Known RNA sequences include retrovirus RNA sequences.

The term “query sequence” means a series of symbolic characters that another sequence is being compared to. As with a reference sequence, the symbolic characters in a query sequence typically represent chemical entities. In some embodiments of the invention, the query sequence is known, i.e., both the order and identity of the building blocks of the sequence are known. In other embodiments of the invention, the query sequence is partially known, e.g., only a portion of the sequence has been identified. In additional embodiments, the function of the query sequence is unknown. For example, the query sequence has been extracted from a biological sample or the query sequence is a portion of a particular genome has been sequenced. In embodiments, the order or identity of the building blocks of at least some of the query sequence may therefore be known, but the identity and/or function of the sequence is not.

In further embodiments of the invention, the query sequence has been identified as having a particular function, e.g., the reference sequence is a DNA sequence that has been identified as the genome of a particular organism. In such cases, the terms “query sequence” and the “reference sequence” can be applied equally well to either of the two sequences that are being compared. In such cases, the sequences are compared to identify regions of similarity between the two sequences that may be a consequence of functional, structural or evolutionary relationships between the sequences.

The term “homology,” as used herein, generally refers to the similarity between sequences. For example, if two sequences are homologous, the sequences share similarities in the order and identity of the building blocks of the sequence. Sequences do not need to be identical to be homologous. Rather, homology is best measured quantitatively, for example, by generating a homology score, which represents the degree of similarity between the sequences.

The term “query sub-sequence” refers to a sequence that has been generated from a query sequence. Likewise, the term “reference sub-sequence” refers to a sequence that has been generated from a reference sequence. For example, a query or reference sequence may be the DNA sequence: A A G T C G A T G. If “A” is assigned the number “1,” and all other letters are assigned the number “0,” the query or reference sub-sequence: 1 1 0 0 0 0 1 0 0 results. For the same DNA sequence, if G is assigned the number “1,” and all other letters are assigned the number “0,” the following sub-sequence results: 0 0 1 0 0 1 0 0 1. Each of the exemplified sequences qualifies as a sub-sequence.

The term “locations,” for example, used in the phrase “determining the locations of at least one difference set in the sub-sequence” refers to the places in the particular sub-sequence that contain a string of numbers that belong to a difference set.

The term “difference set” or “DS” refers to short quasi-random strings and is explained in detail below. Herein, the term “cyclic difference set” is used synonymously with “difference set.”

As used herein, the term “barcode” or “bar code” refers to the visual representation of information on a surface, usually, but not necessarily, consisting of vertical bars of varying widths. In embodiments of the invention, the barcode consists of patterns of dots, concentric circles, or other patterns. In the case of a barcode comprising vertical bars of varying widths, in the present invention the width of the bar varies according to the length of difference sequence located in the sequence or sub-sequence.

The term “insertion sequence” refers to the addition of symbolic characters into a sequence relative to another sequence. The term “deletion sequence” refers to the subtraction of symbolic characters relative to another sequence. The term “indel” refers collectively to either a insertion sequence or a deletion sequence.

As used herein, a “single nucleotide polymorphism,” or “SNP,” in the context of comparing two DNA or RNA sequences, is defined as a single letter difference between two sequences flanked on the left and on the right by at least one letter that is identical in both sequences. For example, in the strings

A C G T A CG T
A A G G A TT T

the second and fourth letters are SNPs but the sixth and seventh letters are indels, as the letter differences are adjacent. The non-adjacency constraint is in the SNP definition because: (1) such modification permits mathematically unambiguous separation of SNPs and indels, and (2) such separation is biologically meaningful as adjacent and closely spaced SNPs often coincide with large indels.

When more than two sequences are considered, if two or more distinct letters appear at a putative SNP position, each pair-wise mismatch is not counted as a separate SNP. Rather, each pair-wise mismatch is counted as one SNP. For example, both triples A-C-T and A-C-C will be considered instances of a single SNP.

In the case of a DNA or RNA sequence, a “coding SNP” is a SNP that occurs in a region of the sequence that encodes for a particular protein. Conversely, a “noncoding SNP” occurs in a region of the DNA or RNA sequence that does not encode a particular protein.

A “synonymous SNP” is a SNP wherein the sequence of the polypeptide that is produced by each DNA in the comparison leads to the same polypeptide sequence. By contrast, if a region of the sequence contains a “non-synonymous SNPs” (“nsSNPs”), a different polypeptide sequence is produced when compared to the sequence not containing the non-synonymous SNP. In a three-way comparison a coding SNP is considered non-synonymous when at least one of the pair-wise SNPs is non-synonymous. For example, there are two pair-wise SNPs in letters A-C-C in the three-way comparison of AA-A-S, one for the pair of strains AA-A and one for the pair of strains AA-S. If either of these pair-wise SNPs is non-synonymous then the three-way SNP is an nsSNP.

### OVERVIEW OF INVENTION

Embodiments of the present invention include methods to rapidly assess genomic sequences. In one embodiment, the invention provides a method to assess similarity, or homology, between a reference sequence and a query sequence. For example, given a query cDNA sequence, a homology search can identify known, similar and unknown genes. A homology search can be generally performed comparing the query sequence with sequence information stored in one or more sequence libraries, or databases, accessible via a communication network, for example, the Internet. According to an embodiment of the homology assessment, the method provides the ability to determine whether the query sequence is “known,” “unknown” or “similar.” “Known” sequences include sequences with substantial sequence identity to existing sequence entries in a sequence database whose function is known. “Unknown” sequences include sequences similar to existing sequence entries in a sequence database, but which lack functional annotation, or those sequences with no matching sequences in existing sequence databases. “Similar” sequences include sequences for which no matches are found in the sequence database, but for which exhibit similarity to existing entries in sequence databases.

Genomic sequences that can be used in the methods according to the invention include DNA, RNA and polypeptide sequences. Exemplary sequence libraries include NCBI GenBank, SWISS-PROT, TrEMBLE, the Genome Sequence database, the European Molecular Biology Laboratory (EMBL) Nucleotide Sequence database, the DNA Database of Japan (DDBJ), RefSeq, Third Party Annotation (“TPA”), Universal Protein (“UnitProt”) resource, ENTREZ, and other like databases.

The invention further provides methods for identifying specific differences between similar sequences on both a coarse grain and fine grain scale. For example, sequences may differ from each other because of the presence of indels or SNPs, defined above. For highly homologous sequences, such as human or bacterial strain DNA, the method provides the ability to identify all or nearly all of these genomic differences.

Knowledge of the differences between sequences can be used either to address basic biological research problems, e.g., investigation of genomic function and evolutionary processes (A. Compagner, “Definitions of randomness,” Amer. J. Phys. 59(8):700-705 (1991)), or in applications such as bacterial strain fingerprinting and monitoring of DNA sequence synthesis orders. In each of these problems selecting the appropriate granularity of analysis is one of the main decisions that has to be made in experiment design.

The present invention is based on the concept that the study of genomic sequence complexity can be cast as a study of the mathematical concept of difference sets. In particular, the present invention recognizes that a complex sequence can be identified as a sequence that contains no repetitions. Such a sequence is associated with the concept of a difference set. As sequences derived from difference sets are repetition-free, the study of genomic sequence complexity can then be viewed as a study of difference sets.

The use of difference sets to model genomic sequences, as disclosed in the present invention, therefore has several advantages: (a) the concept of complexity becomes closely coupled with many biologically relevant phenomena that coincide with the occurrence of repetitive DNA, RNA or protein symbols (A. K. Brodzik, “Quaternionic periodicity transform: An algebraic solution to the tandem repeat detection problem,” Bioinformatics 23(6):694-700 (2007), R. Redon et al., “Global variation in copy number in the human genome,” Nature 444:444-454 (2006)); (b) the use of difference sets enables algebraic analysis, which is advantageous in many applications, as statistics of DNA, RNA and protein sequences vary significantly and reliable estimates are difficult to obtain (Konstantinidis, K. T. et al., “The bacterial species definition in the genomic era,” Philosoph. Trans. The Roy. Soc. B 361:1929-40 (2006); and (c) in contrast to several standard approaches (see, e.g., Li, M. and Vitanyi, P., An Introduction to Kolmogorov Complexity and Its Applications, (New York: Springer) (1997) and R. Van Lambalgen, “The axiomatization of randomness,” J. Symbol. Logic 55(3):1143-1167 (1990)), difference set based complexity measures are easily computable. These advantages are most readily realized in the design of a sequence complexity assessment scheme. However, because one goal of the DNA sequence complexity analysis, for example, is to assess information distance between genomes, it follows that the difference sets on which this analysis relies are also appropriate candidates for DNA sequence homology markers. A further advantage of the present invention is that the difference set model permits a high degree of flexibility in selecting an appropriate sequence variation resolution that can be adapted to a given application.

The methods of the present invention also are advantageous because of the speed in which the steps of the methods are computed. For example, in embodiments, the procedure consists of two essentially algebraic computations: the construction of sequences of homology markers and the alignment of these sequences by a fast implementation of the cross-correlation method. Replacing the analysis of genomic sequences with an analysis of homology marker sequences significantly reduces the number of computations required. This reduction is proportional to the ratio of lengths of these sequences.

Accordingly, in the methods of the present invention, the genomic sequence or sequences are constructed as compact representations in the difference set space, discussed in more detail below. An alignment of these representations permits computationally efficient identification of differences between the sequences. In such methods, at least one query sub-sequence is created from the query sequence. As discussed above, the query sub-sequence can be a binary representation of the query sequence, wherein one of the symbols in the sequence is designated as “1” and the remaining symbols are designated as “0”. In other embodiments, the query sub-sequence is represented in a mathematically different fashion, for example, a quaternionic representation of the sequence can be used (Brodzik, A. K., “Quaternionic periodicity transform: An algebraic solution to the tandem repeat detection problem,” Bioinformatics 23(6):694-700 (2007)). In many cases the analysis of the entire genomic sequence might not be necessary. A satisfactory sequence homology assessment, for example, can be obtained from the analysis of a single binary sequence. The invention therefore provides methods wherein single and multiple representations of the query sequence are created. As discussed, the query sequence and reference sequence can be a DNA sequence, an RNA sequence or a polypeptide sequence.

In applications such as DNA sequence compression and phylogenetic tree reconstruction where comparison of more distant sequences is desired, the construction of a representation of the entire sequence may be needed. In such circumstances, representation of the query sequence as difference set families and almost difference set families, described below, can be done.

Methods to Assess Homology

In embodiments of the homology assessment methods of the present invention, following the creation of at least one query sub-sequence represented as a binary or quaternionic string, for example, the locations, or the distribution, of at least one difference set in the query sub-sequence can then be determined, for example, by a running window analysis, the details of which are described below. Other suitable methods to determine difference set distributions are known to those skilled in the art.

Suitable difference sets for use in the homology determination methods of the invention include, but are not limited to, the (7, 3, 1) difference set, (13, 4, 1) difference set, and (11, 5, 2) difference set. A preferred difference set is the (7,3,1) difference set. The choice of difference set will depend on a number of factors, such as the information that is sought from the analysis. In general, larger difference sets are more suitable for applications in which a coarser grain analysis of the sequence is desired, whereas smaller difference sets are more suitable for determining finer grain differences between sequences. In embodiments of the invention, the analysis is performed using a larger difference set to identify large-scale differences, followed by the analysis using a smaller difference set for higher granularity

The invention also provides methods of representing the distribution of at least one difference set in the query sub-sequence in the form of a barcode. In one embodiment, the barcode graphically illustrates the distribution of a particular difference set as a function of nucleotide number. The advantage of a barcode representation of the distribution is that it allows a quick, visual assessment of the distribution of the difference set in the sequence of interest.

After determining the locations of at least one difference set in the query sub-sequence, in embodiments of the invention, the locations of the difference set in the query sub-sequence are compared to locations of the difference set in a reference sub-sequence to determine the similarities and/or differences between the query sequence and the reference sequence. In embodiments of the invention, the distributions of difference sets in both the query sequence and the reference sequence are represented by barcodes, as discussed above. The barcodes can be compared to determine similarities in the distributions of the difference set in the sequences.

In additional embodiments, the distributions of difference sets in the two or more sequences being compared are converted to shorter, sequences of gaps between subsequent locations of difference sets (i.e., the difference set sequences), to allow the computation of the homology of the sequences. The conversion of the distribution of the difference sets into more compact representations is discussed below, where it is understood there is more than one method to convert the distribution information into representations that aid in the determination of homology.

Following the conversion of the difference sets, the sequences can be aligned, for example, by the cross-correlation method. Additional alignment methods are discussed above and are known to those of skill in the art. In embodiments, the phase-only Fourier space cross-correlation method is employed to analyze homology. The Fourier space cross-correlation method is discussed in detail below.

In embodiments of the invention, a global homology score is calculated that represents a degree of homology between the reference sequence(s) and query sequence(s). A homology score can be calculated by a variety of methods, readily apparent to one of skill in the art. For example, the global homology score can be a ratio of the number of identical nucleotides in the query sub-sequence and the reference sub-sequence to the total number of symbols in either the query sequence or the reference sequence.

Methods of Determining Indels

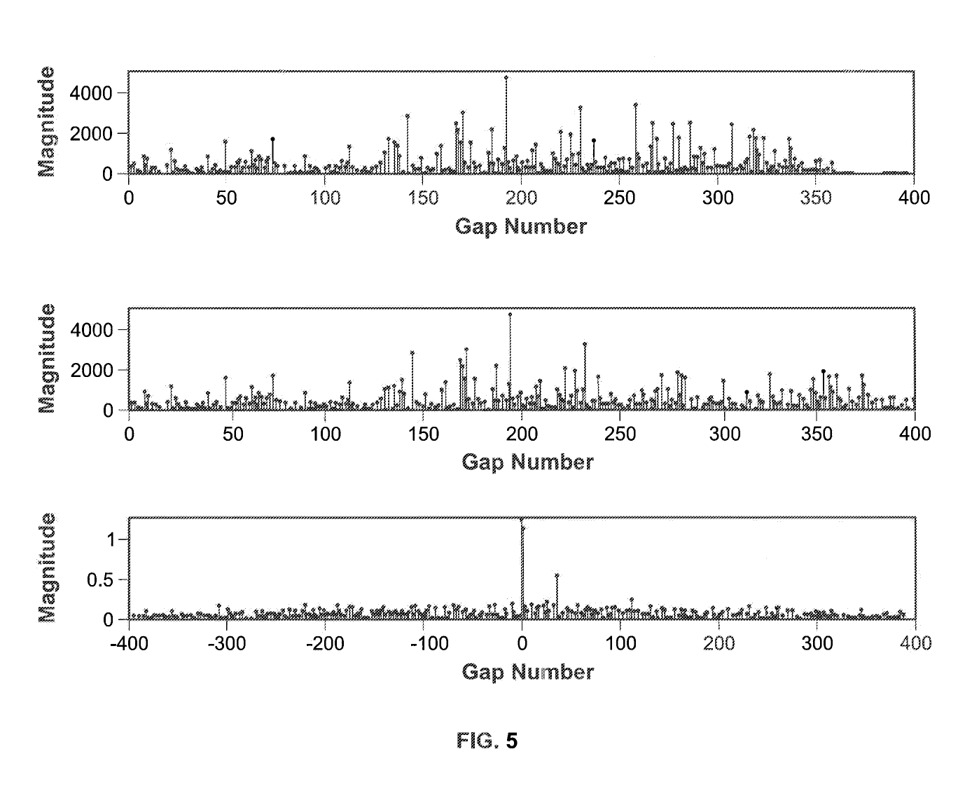

In a further embodiment, the invention provides a computer-based method of determining the presence and identity of an insertion sequence, a deletion sequence, or a combination thereof, in at least one query sequence as compared to at least one reference sequence. In embodiments of the invention, the method of determining the presence and/or identity of indels in a sequence comprises determining a distribution of at least one difference set in a query sub-sequence, as described above, and comparing the distribution of the difference set in the query sub-sequence with a distribution of the difference set in a sub-sequence of the reference sequence, also as described above. The result of the comparison, achieved by Fourier space phase-only cross-correlation between the sequences, for example, allows identification of a portion of the query sub-sequence that is not homologous with the reference subsequence, wherein the non-homologous portion indicates the presence of an insertion sequence, a deletion sequence, or both. In embodiments, computing the comparison between the sequences results in a plot that reveals the presence of matching segments and mismatching segments in the difference set sequences, see, e.g., FIG. 5, which shows the difference set sequences associated with a particular plasmid along with the cross-correlation sequence, which is the bottom plot.

In embodiments, the matching and mismatching segments of the query sequence and reference sequence can be identified by comparing the first difference set sequence with the appropriately shifted second difference set sequence. In embodiments, and depending on the sequences being compared, a comparison between the matching segments reveals segments separating the matching segments, e.g., the mismatching segments, thus revealing the presence of, for example, insertion or deletion segments. If desired, the fine structure of the indels can also be determined by identifying the occurrence of zeros in the matching segments of the difference set sequences. The occurrence of zeros within matching segments is a consequence of differences in lengths of associated sections of sequences, which, in turn, are due to the occurrence of indels. Accordingly, the invention also provides methods to determine indels both on a coarse grain and fine grain scale. The methods for determining indels in at least one query sequence as compared to at least one reference sequence can be applied to any appropriately sized genomic or polypeptide sequence. In embodiments, the genomic sequence is a DNA or RNA sequence.

Suitable difference sets for use in the indel determination methods of the invention include, but are not limited to, the (7, 3, 1) difference set, (13, 4, 1) difference set, and (11, 5, 2) difference set. A preferred difference set is the (7,3,1) difference set. The choice of difference set will depend on a number of factors, such as the information that is sought from the analysis. In general, larger difference sets are more suitable for applications in which a coarser grain analysis of the sequence is desired, whereas smaller difference sets are more suitable for determining finer grain differences between sequences. In embodiments of the invention, the analysis is performed using a larger difference set to identify large-scale differences, followed by the analysis using a smaller difference set for higher granularity.

Methods to Determine SNPs

The present invention further provides computer-based methods of identifying at least one single nucleotide polymorphism (SNP) in at least one query sequence as compared to at least one reference sequence. The method includes a step that determines a distribution of at least one difference set in a query sub-sequence, as discussed above with regard to homology determination methods and methods of determining indels. The method further includes comparing the distribution of the difference set in the query sub-sequence with a distribution of the difference set in a sub-sequence of the reference sequence, as also discussed above with respect to homology determination methods and methods of determining indels. In embodiments, the method to determine SNPs in a query sequence also includes identifying indels in the query sub-sequence and removing regions of sequence in the query sub-sequence or the reference sequence, or both, which contain indels, to create modified sub-sequences. Methods of identifying indels are discussed in the previous section, and in detail below. Following the removal of indels, single nucleotide polymorphisms in the modified sub-sequences from in the previous step are identified. In embodiments, the step of identifying the SNPs includes a point-wise comparison of the modified subsequences. The methods for determining SNPs as provided herein, can be applied to any appropriately sized genomic or polypeptide sequence. In embodiments, the genomic sequence is a DNA or RNA sequence.

Suitable difference sets for use in the methods of determining SNPs method include, but are not limited to, the (7, 3, 1) difference set, (13, 4, 1) difference set, and (11, 5, 2) difference set. A preferred difference set is the (7,3,1) difference set. The choice of difference set will depend on a number of factors, such as the information that is sought from the analysis. In general, larger difference sets are more suitable for applications in which a coarser grain analysis of the sequence is desired, whereas smaller difference sets are more suitable for determining finer grain differences between sequences. In embodiments of the invention, the analysis is performed using a larger difference set to identify large-scale differences, followed by the analysis using a smaller difference set for higher granularity.

### The Difference Set Model

Introduction

Difference sets (“DSs”) are short quasi-random strings. The rationale for using DSs as sequence markers is that when DNA sequences are highly homologous, so are the sequences of DS locations. Conversely, in regions where DNA sequences differ, so do the DS sequences. This is convenient as the analysis of DNA sequences can then be replaced by the analysis of much sparser, and therefore easier to compute, DS sequences.

The concept of difference sets in certain respects resembles the idea of spaced seeds which was recently proposed to improve efficacy of sequence alignment algorithms. Brown, D. G., “A survey of seeding for sequence alignment,” in Bioinformatics Algorithms: Techniques and Applications (Hoboken, N.J.: Wiley) pp. 117-141 (2008), Ma, B. et al., “PatternHunter: Faster and more sensitive homology search,” Bioinformatics 18(3):440-445 (2002). Spaced seeds confer an advantage because hits to spaced seeds are more independent than hits to non-spaced seeds. L. Zhang, “Superiority of spaced seeds for homology search,” IEEE Trans. Comp. Biol. Bioinform. 4(3):496-505 (2007). While spaced seeds often incorporate probabilistic a priori information such as open reading frame constraints, thereby tailoring the design to the application at hand, difference sets are general algebraic constructs, defined solely by their correlation properties. This close coupling with algebraic properties is beneficial. For example, the absence of repetitions in the difference set strings suggests that these strings are more likely than other markers to be free from recent, repetition-based mutations (such as those associated with VNTRs), and from sequencing and short-read assembly errors which occur more often in repetitive sequence regions. Difference sets might also have a slight advantage over arbitrary strings in terms of abundance: in arbitrary sequences short non-repetitive patterns tend to occur more often than those that include repetitions. A. DasGupta, Sequences, Patterns and Coincidences preprint.

Apart from distinction in construction, there is also a difference in how spaced seeds and difference sets are embedded in their respective applications. While, as with spaced seeds, difference sets are used herein to identify regions of sequence similarity, the methods are different from the usual sequence alignment approach at least because in that difference sets are not grown to larger matching sequences, but instead use the distribution of difference sets in DNA sequences directly to evaluate DNA sequence homology. This approach reduces dimensionality of the problem significantly. For example, for certain bacterial sequences the ratio of DNA and difference set sequence lengths is of the order of a few hundreds.

The second component of the homology evaluation procedure involves a fast realization of the cross-correlation-based sequence alignment algorithm. This realization is based on sequence matching in the Fourier space. Multiplicative complexity of this approach is of the order of n log n, which is much better than the multiplicative complexity afforded by most standard methods. Fourier space cross-correlation has been explored previously in several works, including K. Katoh et al., “MAFFT: A novel method for rapid multiple sequence alignment based on fast Fourier transform,” Nucl. Acids Res. 30(14):3059-3066 (2002) and Rockwood, A. L. et al., “Sequence alignment by cross-correlation,” J. Biomole. Techn. 16(4):453-458 (2005). In embodiments of the invention, a variation on this approach relies on matching Fourier space sequences by their phases only. This variation has the advantage that certain spurious sequence matches due to repetitive components of the DNA sequence are avoided, and therefore unambiguous determination of matching sequence segments can be made.

While subsampled representations of DNA sequences obtained by difference set analysis are appropriate for homology studies of closely related genomes, some applications, such as DNA sequence compression and phylogenetic tree reconstruction, may require sequence interrogation at very fine scales. This task necessitates the use of more complex tools that are capable of capturing the predominantly mixed, random-repetitive character of the DNA sequence. In embodiments of the invention, these tools are based on combinatorial constructions known as difference set and almost difference set families.

### DNA Symbol Representation

In this section, difference sets are defined and show how they can be used to model pseudorandom DNA strings.

The DNA sequence is a symbolic sequence made up of four letters, A, C, G, and T, that represent the four nucleotides of the genetic code: adenine, cytosine, guanine, and thymine. Prior to processing the DNA sequence, the symbolic characters must be assigned numerical values. The simplest method of numerically representing the DNA sequence is to split it into four sub-sequences associated with the four nucleotides, and to denote by “1” and “0” the occurrence and absence of each letter in the relevant subsequence. Alternative DNA symbol representations, using complex and hypercomplex number systems, convenient in certain tasks, are given, among others, in Anastassiou, D., “Genomic signal processing,” IEEETrans. SP 18:820 (2001) and Brodzik, A. K., “Quaternionic periodicity transform: An algebraic solution to the tandem repeat detection problem,” Bioinformatics 23(6):694-700 (2007).

For example, the symbolic sequence

ACCGAT

can be represented by the four binary subsequences
100010 (A)
011000 (C)
000100 (G)
000001 (T).

Given this representation, each binary subsequence can then be analyzed independently.

### Cyclic Difference Sets

While difference set theory is considered an integral part of combinatorial design theory, the field incorporates methods from many branches of mathematics. One of the first mentions of difference sets was in connection with a certain problem in additive number theory. P. Erdos and P. Turan, “On a problem of Sidon in additive number theory,” J. London Math. Soc. 3(270):212-215 (1941), S. Sidon, “Ein Satz über Trigonometrische Polynome and Seine Anwendung in der Theorie der Fourier-Reihen,” Math. Ann. 106:536-539 (1932). The systematic study of difference sets started with the paper by a group theorist, Marshall Hall (M. Hall, “A survey of difference sets,” Proc. Amer. Math. Soc. 7:975-986 (1956), who introduced the concept of multipliers. Subsequent developments disclosed the relation of difference sets to finite geometry techniques. Today, due to their association with sequences with ideal correlation properties, difference sets are used in several applications, including communications, radar, navigation, cryptography, coding theory, and statistical design. The seminal works on this subject are Baumert, L. D., Cyclic Difference Sets (New York: Springer) (1971) and Lander, E. S., Symmetric Designs: An Algebraic Approach (New York: Cambridge University Press) (1983).

It is convenient to define difference sets using the language of group theory. Suppose G is the additive group of integers modulo v and D is a k-subset of G. The set D is a (v, k, λ) cyclic difference set of if in the set of all differences of distinct elements in D

Δ={d−d′|d,d′δD,d≠d′}

every nonzero element of occurs exactly λ number of times. Although formally cyclic difference sets are a subcategory of a larger family of combinatorial designs known as difference sets, for brevity in this work cyclic difference sets are referred to as difference sets.

The main unresolved problem in the study of difference sets pertains to their existence. Many rules guide the construction of difference sets. For example, difference sets satisfy the well-known necessary condition

(v−1)λ=k(k−1).

If D is a (v, k, λ)-difference set, then the set D̅=G\D is a−(v, v−k, v−2k+λ)-difference set. One of the well-known results permits verifying the equivalence of difference sets. Two difference sets D and D′ are called equivalent if D′ has the form tD+g for some integer t relatively prime to v and for some gεG. It follows that shifts and reflections of difference sets are difference sets. Examples of “small” difference sets include the (7,3,1)-difference set D={1, 2, 4}, the (13, 4, 1)-difference set D={0, 1, 3, 9}, and the (11, 5, 2)-difference set D={1, 3, 4, 5, 9}. Research in this field continues, and an up-to-date repository of difference sets with k≦300 is maintained at www.ccrwest.org/diffsets/diff_sets/index.html.

One of the key properties of difference sets is their association with binary sequences with a perfect two-valued (k, λ) autocorrelation. For example, the (7, 3, 1)-difference set corresponds to the sequencer 0110100. To see that this sequence has a two-valued autocorrelation observe that the inner product of any two rows of the following array yields the same value, equal in this case to one
0110100
0011010
0001101
1000110
0100011
1010001
1101000.

The perfect autocorrelation property of sequences associated with difference sets makes difference sets useful in studies of DNA sequence complexity. Sequence complexity is intrinsically coupled with the lack of local regularities, or alternatively, with the concept of randomness. Since a sequence associated with a difference set displays no repetitions, such sequence can be referred to as algebraically random. In effect, the information content of a DNA sequence can be assessed in terms of its relation to a difference set. The simplest way of performing this assessment is a direct comparison.

Given the DNA symbol representation shown in the previous subsection, the association of DNA subsequences with difference sets is straightforward. Take, for example, the sequence

AACAGCTG CAGT T

This sequence can be represented by the four subsequences
1101 0000 0100 0 (A)
0010 0100 1000 0 (C)
0000 1001 0010 0 (G)
0000 0010 0001 1 (T).

It follows from inspection that the first subsequence is associated with the difference set (13, 4, 1), the second and third ones are semiperiodic, and the forth one is of neither type. Below it will be shown that sequences of this type can be modeled by combinatorial generalizations of difference sets.

### Phase-Only Fourier Space Cross-Correlation

One of the most efficient algorithms for DNA sequence alignment is the cross-correlation method. The main computations of the procedure are the discrete Fourier transform and a pointwise multiplication of two complex Fourier transform sequences. The overall computational complexity of the algorithm is n log n, which is significantly lower than the n² afforded by methods based on dynamic programming (Lipman, D. J. and Pearson, W. R., “Rapid and sensitive protein similarity search,” Science 227:1435-1441 (1985), S. B. Needleman and C. D. Wunsch, “A general method applicable to the search for similarities in the amino acid sequence of two proteins,” J. Mol. Biol. 48:443-453 (1970), Smith, T. F. and Waterman, M. S., “Identification of common molecular subsequences,” J. Mol. Biol. 147:195-197 (1981) and suffix trees (Delcher, A. L. et al., “Alignment of whole genomes,” Nucl. Acids Res. 27(11):2369-2376 (1999), Kurtz, S. and Schleiermacher, C., “REPuter—Fast computation of maximal repeats in complete genomes,” Bioinformatics 15:426-427 (1999). The popular BLASTn and MegaBLAST algorithms (of the BLAST family) are reputed to be faster. However, the complexity of these methods is difficult to evaluate since the number of computations required depends on many parameters, including the length of the seed sequence, the drop-off value for seed extension, treatment of gaps, sequence similarity, etc. (Ma, B. et al., “PatternHunter: Faster and more sensitive homology search,” Bioinformatics 18(3):440-445 (2002), Korf, I., et al., BLAST (Sebastopol, Calif.: O'Reilly) (2003)). The computational complexity of the cross-correlation approach, on the other hand, is easily quantifiable, it does not depend on the data, and it does not have inherent limitations on the sequence size. This approach is the basis of several existing algorithms of which perhaps the best known is MAFFT (Katoh, K., Misawa, K., Kuma, K., and Miyata, T., “MAFFT: A novel method for rapid multiple sequence alignment based on fast Fourier transform,” Nucl. Acids Res. 30(14):3059-3066 (2002)).

A comparison has been made between the standard magnitude-and-phase cross-correlation and the lesser known, but closely related, phase-only cross-correlation. A. K. Brodzik, “Phase-only filtering for the masses (of DNA data): A new approach to DNA sequence alignment,” IEEE Trans. Signal Processing 54(6):2456-2466 (2006). A brief description of this approach is given below.

Define the cyclic cross-correlation, or the MF (matched filter), of two real discrete sequences x and y by

$$\begin{matrix}z ( n ) = x ( n ) * y ( n ) \\ = {\sum }_{m = 0}^{N - 1} x ( n + m ) y ( m ) ,\end{matrix}$$

$$0 \leq n < N$$

with n+m taken modulo N. Take x, y and z and to be the discrete Fourier transforms of x, y and z, respectively, and denote by y̅ the complex conjugate of y. Since

z(k)=x(k) y̅(k)

the cross-correlation can be efficiently implemented by computing

z(n)=DFT⁻¹{x(k) y̅(k)}.

An alternative measure of sequence similarity is given by the SPOMF (symmetric phase-only matched filter), defined by

$$w ( n ) = {DFT}^{- 1} \{ \frac{x ( k ) \overline{y} ( k )}{\vert x ( k ) \overline{y} ( k ) \vert} \} , \\ x ( k ) and \overline{y} ( k ) \neq 0.$$

The value s=arg max_n w(n) is equal to the cyclic shift of y that among all cyclic shifts of y produces the sequence most similar to x. When y=x then s=0. When y≠x then there might be several values of n for which w(n) is greater than a predefined threshold. These values are called the dominant values of the phase-only cross-correlation. They correspond to cyclic shifts of y that produce alignments of segments of x and y. Increasing slightly the generality of the problem, one might choose x to be a query sequence and y a concatenation of all sequences in a database. In this case, the analysis proceeds as before, with the difference that the dominant values of the cross-correlation now point to the most homologous sequences (with the query sequence) in the database. Since x and y are of disproportional lengths, it is often convenient to implement this computation by repeatedly correlating with appropriately chosen segments of y.

SPOMF was proposed two decades ago in optical signal processing (J. L. Horner and P. D. Gianino, “Phase-only matched filtering,” Appl. Opt. 23(6):812-816 (1984), and heuristic arguments have been made that the method is superior to the standard approach in terms of misalignment resolution and robustness to noise. Since then it has been successfully applied to image registration, watermarking, and sonar, among others. It has been shown that when applied to DNA sequences SPOMF produces a more accurate sequence alignment by reducing the effect of spurious sequence segment matches that arise due to occurrence of symbol repetitions.

### Application of Difference Sets

The difference set model can be applied to genomic sequences of sufficient length. For example, in embodiments of the invention, a sequence of at least 1,000 symbols is preferred. The model can be applied to DNA, RNA and polypeptide sequences. The following section provides an example of the application of the DS model to bacterial genomes. In particular, the distributions of difference sets in several DNA sequences of varying degree of homology are compared. By a distribution of difference sets is meant an indicator sequence of length equal to the length of the DNA sequence under consideration, where “one” marks the occurrence of a difference set in the DNA sequence and “zero” the absence thereof. As part of this study, the relative abundance of difference sets in DNA sequences is evaluated. This abundance informs both how similar these sequences are to an algebraically random reference sequence and the feasibility of constructing parsimonious representations of these sequences in the difference set space.

The present example investigates the B. anthracis genome. The reason for this choice is the fact that B. anthracis strains are highly monomorphic, which makes differentiation of these sequences an especially difficult problem (Keim, P. et al., “Anthrax molecular epidemiology and forensics: Using the appropriate marker for different evolutionary scales,” Infection, Genet. Evol. 4:205-213 (2004), Lista, F. et al., “Genotyping of bacillus anthracis strains based on automated capillary 25-loci multiple locus variable number tandem repeats analysis,” BMC Microbiol. 6:1-15 (2006), Marston, C. K. et al., “Molecular approaches to identify and differentiate bacillus anthracis from phenotypically similar bacillus species isolates,” BMC Microbiol. 6:22-28 (2006), Pallen, M. J. et al., Bacterial Pathogenomics (Washington, D.C.: ASM Press) (2007), and the genome demonstrates the efficacy of the DS model. In general, the B. anthracis genome is made up of chromosomal DNA and two plasmids, pXO1 and pXO2. The occurrence of the conserved plasmid sequences in the genome is particularly important, as it often coincides with the strain toxicity. However, not all strains contain both plasmids. Even when they do, the plasmid sequences need not be identical. Plasmids can be exchanged between distinct B. anthracis strains, in the process undergoing sequence alterations, including mutations, deletions and horizontal gene transfer. In effect, identification of these genomic differences is essential for determination of the recent evolutionary changes in the B. anthracis genome and for evaluation of the pathogenic potency of a B. anthracis strain.

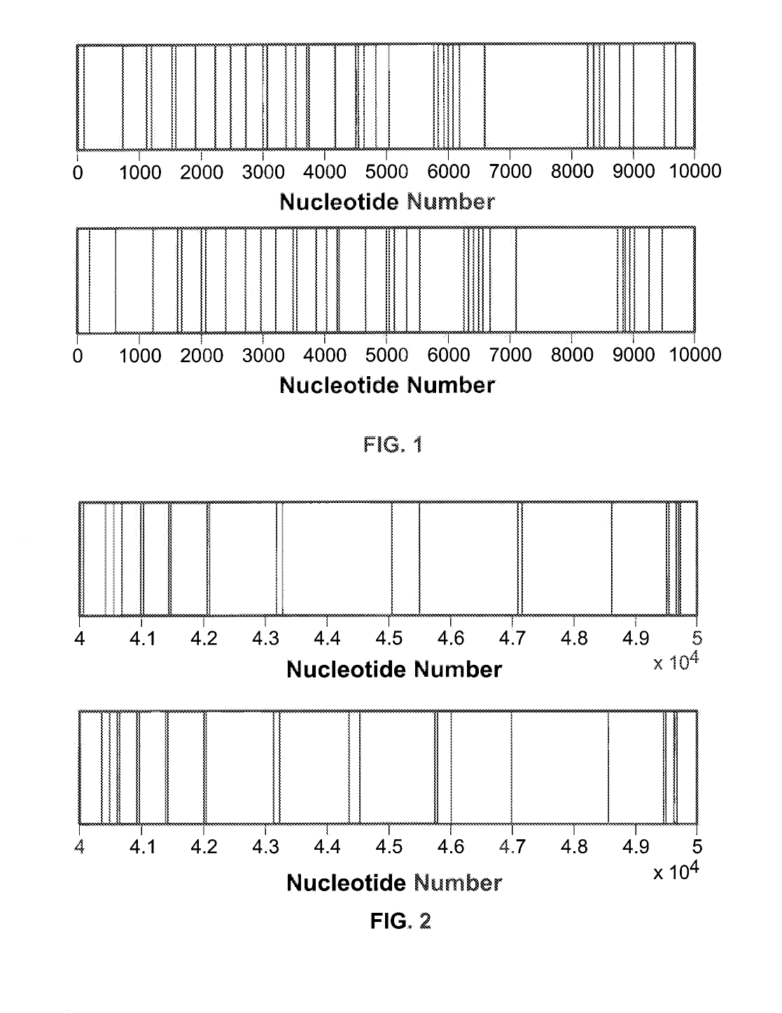

In the first experiment the abundance of the difference set (7, 3, 1) in two sequences of the B. anthracis pXO2 plasmid is evaluated, associated with the strains Ames Ancestor (AE017335) and Pasteur (AF188935). The difference set was chosen because it is the shortest difference set and therefore it is likely to sample the DNA sequence at a higher density than other difference sets. Longer difference sets can be chosen when lower density sampling is required. The Ames Ancestor plasmid contains 1672 (7, 3, 1) difference sets (569 in A, 294 in C, 171 in G, and 638 difference sets in the T subsequence), and the Pasteur plasmid contains 1691 (7, 3, 1) difference sets (573 in A, 296 in C, 175 in G, and 649 difference sets in the T subsequences). The difference sets are dispersed fairly uniformly throughout the plasmids and the distribution of the difference sets in both sequences follows a similar pattern (see FIG. 1).

Excluding certain relatively short (less than 500 bp (base pairs)) flanking sequences, the central portions of the Ames Ancestor and Pasteur plasmid sequences constitute segments of length 94 728 and 94 705 bp, respectively. These segments can be identified by matching the difference sets located at the extremes of plasmids that are identical in both sequences. The segments vary in 75 places. The genomic differences include VNTRs (variable number tandem repeats) (about 50%), putative SNPs (single nucleotide polymorphisms) (about 25%) and nonrepeat related indels (insertions/deletions) (about 25%). VNTRs are a small fraction of all significant (longer than six symbols) exact tandem repeats. The total number of tandem repeats in plasmids is 2178. This number is somewhat smaller than the number of difference sets when both orientations of difference sets are accounted for (which then doubles the total number of difference sets). The abundance of difference sets in the plasmid sequence is about 25%, which is similar to the abundance of SNPs and indels.

In the second experiment evaluated the abundance of the difference set (7, 3, 1) was evaluated in two sequences of B. anthracis pXO1 plasmid, associated with the strains Ames Ancestor (AE017336) and Sterne (NC_{—}001496). The Ames Ancestor plasmid contains 3479 (7, 3, 1) difference sets (1313 in A, 360 in C, 496 in G, and 1310 in the T subsequences), while the Sterne plasmid contains 3528 (7, 3, 1) difference sets (1318 in A, 397 in C, 492 in G, and 1301 in the T subsequences). While the density of the difference sets in pXO2 and pXO1 sequences is similar, in contrast to the pXO2 plasmid the distribution of the difference sets in the two pXO1 strains varies at several places. This is illustrated in FIG. 2, which shows an example of distinct “barcodes” associated with subsequences of the pXO1 plasmids. The difference in barcodes is a consequence of the occurrence of a large insertion segment between 44 000 and 48 000 bp in the plasmid sequence. Similar barcode mismatches can be observed in several other parts of pXO1, e.g., in the segment located between 117 000 and 161000 bp.

The above analysis was repeated for two larger difference sets, (13, 4, 1) and (25, 5, 1), and for all four subsequences A, C, G, and T. There was no clear advantage to using any of the four subsequences. However, predictably, the sequence associated with the difference set (7, 3, 1) permitted the highest resolution comparison of DNA sequences.

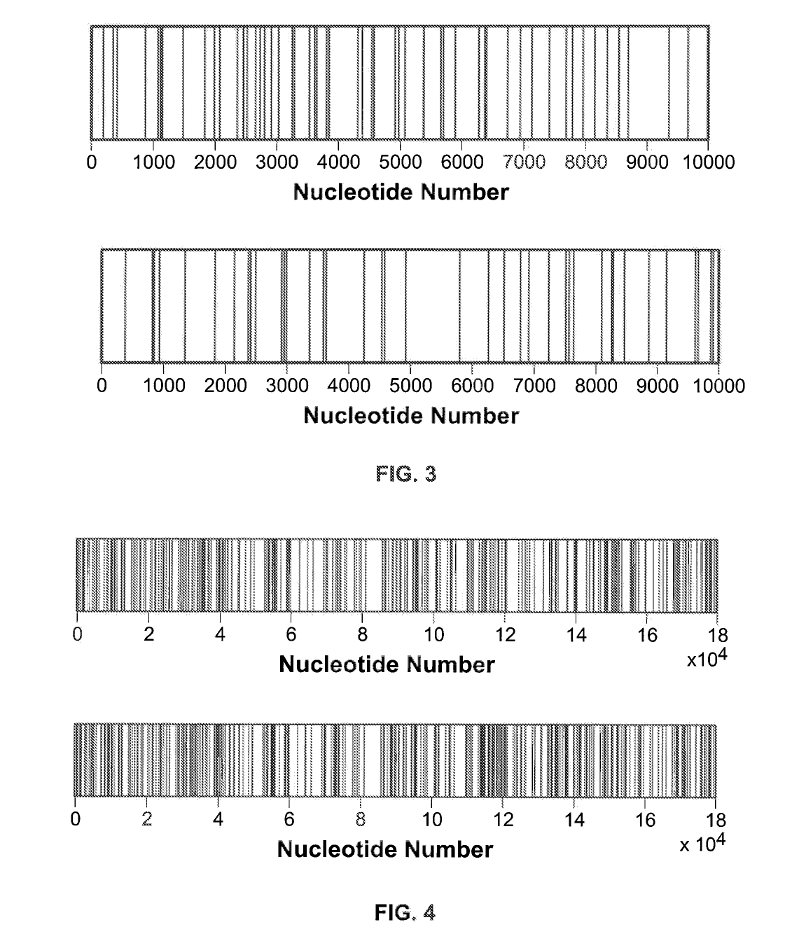

To verify that difference sets in non-homologous sequences do not occur at similar locations as in homologous sequences, the computed difference set distributions in two 10000-point random sequences is evaluated. As illustrated in FIG. 3, the two distributions are distinct. The last experiment is not meant as a “proof” of mismatch of random sequences in the difference set space (one is not needed), but as an illustration of the following. In the canonical case (equal number of the four nucleotides in a sequence) the expected number of symbol matches between two random sequences is 25%. In contrast, the number of symbol matches among homologous segments typically exceeds 99% (by definition, the only non-matching symbols are SNPs). FIGS. 1 through 3 demonstrate that in addition to the difference in the number of symbol matches, the difference set matches in homologous segments are adjacent, while the difference set matches in random segments follow a random pattern.

### Detection of SNPs

The method of the present invention also provides the ability to detect and identify SNPs. The advantages of identifying SNPs is that they are highly concentrated in coding regions, have fixed length, and have lower susceptibility to short read sequencing errors that other markers. The following section the occurrence of SNPs in the three main strains of the B. anthracis genome: Ames Ancestor, Ames and Sterne. It is shown that SNPs are abundant in the B. anthracis genome and that they are distributed relatively uniformly throughout the sequence. These findings demonstrate that the B. anthracis SNPs can be used effectively as part of an increased resolution, multi-tier strain differentiation scheme for the analysis of moderately incomplete, noisy or uncertain data. The SNP detection approach used here is based on an advanced design theory construction known as the cyclic difference set. Chang, P. et al., “Structure alignment based on coding of local geometric measures,” BMC Bioinform. 7:110 (2006). In this approach the comparison of DNA sequences is replaced by the comparison of cyclic difference set distributions associated with these sequences. The similarity of these distributions is used first to assess DNA sequence homology and subsequently to identify indels and SNPs.

The algorithm consists of two main stages: indel detection and SNP detection. In the first stage, DSs in two homologous DNA sequences are identified and, subsequently, the locations of these occurrences are compared. Because a difference in DS sequences marks the occurrence of an indel, mismatching segments are removed from the DS sequences. In embodiments of the invention, some small indels might remain undetected in this stage and therefore an additional test for the occurrence of indels may be required in the second, SNP detection stage. In the second stage, the DS sequences are mapped back to “new”, indel-free DNA sequences. These DNA sequences differ only by nucleotide mismatches. Once adjacent mismatches are filtered, SNPs are easily identified by a point-wise comparison of the modified nucleotide sequences.

### Beyond Difference Sets

While subsampled representations of DNA sequences obtained by difference set analysis are appropriate for homology studies of closely related genomes, some applications, such as DNA sequence compression, phylogenetic tree reconstruction and comparison of more distant sequences, may require sequence interrogation at very fine scales. In these cases, the construction of a representation of the entire DNA sequence, including segments made up of mixed and longer strings, is needed. This task requires the use of more complex tools, such as difference set and almost difference set families. In this section investigate existence conditions for these constructions are investigated.

### Difference Set Families

Previously, the analysis was restricted to individual DNA subsequences, associated with the symbols A, C, G, and T. However, it is of at least an equal interest to evaluate the DNA sequence as a whole. To do so, the concept of a difference set family can be used.

Let G be an additive group of order v. A collection of sets

(D₁, . . . , Dₘ|DᵢεG,|Dᵢ|=k, 1≦i≦m}

is called an m-fold (v, k, λ)-difference set family in G if the multiset union

Δ_{f}=∪{d−d′|d,d′εDᵢ, d≠d′}

contains every element in G\{0} exactly k times.

If Dᵢ∩Dⱼ=0 for all i≠j then the difference set family is called block disjoint. If Dᵢ∪ . . . ∪Dₘ=G then the difference set family is called complete. By the existence condition of difference sets

mk(k−1)=λ(v−1),

it follows that mk≠v, and hence there is no complete block disjoint difference set family.

For example, the sets D₁={0,1,2,4,8}, D₂={0,1,3,6,12) and D₃={0,2,5,6,10} form a difference set family over z₁₃, but the family is neither block disjoint nor complete. To obtain a construction that is in some way close to a complete block disjoint difference set family one needs either to relax either the definition of the difference set or the definition of the complete block disjoint difference set family. The next two subsections illustrate the two cases.

Almost Difference Sets: the Case of (4k, k, 0, t)

While the count of individual nucleotide bases in bacterial genomes often varies considerably, a convenient simplified model for the DNA sequence is one that assumes an equal frequency of occurrence of the four DNA symbols. Such a model requires a decomposition of the DNA sequence into four non-overlapping difference sets, (4k, k, λ). Unfortunately, by the existence condition of Section VII-A, difference sets with v=4k do not exist. Alternatively, one can relax the difference set condition and only require that the autocorrelation sidelobe not be greater than λ>0. A combinatorial design satisfying this relaxed condition is called an almost difference set. K. T. Arasu et al., “Almost difference sets and their sequences with optimal autocorrelation,” IEEE Trans. Inf. Theory 47(7):2934-2943 (2001), A. Pott and S. P. Bradley, “Existence and nonexistence of almost-perfect autocorrelation sequences,” IEEE Trans. Inf. Theory 41(1):301-304 (1995). Formally, a k-subset D of an additive group G of order v is called a (v, k, λ, t)-almost difference set in G if the multiset

Δ′={d−d′|d,d′εD, d≠d′}

contains t elements in G\{0} exactly λ times and v−1−r elements in G\{0} exactly λ+1 times. The necessary condition for almost difference sets is

(λ+1)(v−1)≡t(mod k(k−1)).

Furthermore, a collection of sets

{D₁, . . . , Dₘ|DᵢεG, |Dᵢ|=k, 1≦i≦m}

is called an m-fold (v, k, λ, t)-almost difference set family in G if the multiset union

Δ′_{f}=∪{d−d′|d,d′εDᵢ, d≠d′}

contains t elements in G\{0} exactly λ times and v−1−t elements in G\{0} exactly λ+1 times. Block disjoint and complete almost difference set families are defined analogously to difference sets. It is apparent that when t=0 or t=v−1 almost difference sets are difference sets.

Since (k²−k)/(4k−1)>1 for k−4, it follows that the longest set that satisfies the conditions v=4k and λ=0 is the (16, 4, 0, 3)-set D=(0, 1, 3, 7). An example of a 4-fold block disjoint complete (16, 4, 0, 3) combinatorial design is
{(0, 1, 3, 7), (8, 9, 11, 15), (2, 4, 13, 14), (5, 6, 10, 12)};
   with the associated sequence set
1101000100000000
0000000011010001
0010100000000110
0000011000101000,
   however, this collection of sets in not an almost different set family.

Relating the above result to DNA sequences, it can be said that no nontrivial DNA sequence having an equal abundance of the four nucleotides is algebraically random. While this result obstructs the design of a random sequence model using standard constructions, the difficulty can be circumvented by quantifying the degree of randomness of the DNA sequence and by generalizing the concept of an almost difference set family. For example, suppose that k is fixed and 0≦λ<λₘₐₓ, where λₘₐₓ specifies the sidelobes of a periodic sequence. Then a DNA sequence can be expressed in terms of almost difference sets, provided that the complete block disjoint difference set family condition is met by some subset of the set

{D₁^{λ}, . . . , Dₘ^{λ}Dᵢ+εG, |Dᵢ^{λ}|=k, 1≦λ≦λ<λₘₐₓ}.

Moreover, the degree of randomness of the DNA sequence can then be related to the largest value of λ associated with the subset.

### Almost Complete Families: the Case of

$$( 4 {r}^{2} + 1 , {r}^{2} , \frac{{r}^{2} - 1}{4} )$$

There are several known instances of block disjoint difference set families that are almost complete, in the sense that their union is nearly equal to G. In one of these cases the construction of a difference set family relies on the set

$$( 4 {r}^{2} + 1 , {r}^{2} , \frac{{r}^{2} - 1}{4} ) ,$$

where r is an odd integer and v=4r²+1 is a prime. The difference set is made up of the fourth powers in the Galois field GF (v), that is D={α^{4j}, 1≦j [symbol] v}, where α is a primitive root modulo v. Each of the sets D, αD, α²D and α³ is a difference set. Since these sets are disjoint and their union is equal to G\{0}, they form a 4-fold almost complete block disjoint difference set family. The family has a reasonable granularity (i.e., v=37,101, 197, etc.) and hence is suitable for the analysis of DNA sequences in multiscale spaces. The smallest family is generated by r=3. In this case (v, k, λ)=(37, 9, 2), α=5 and
D=(1, 7, 9, 10, 12, 16, 26, 33, 34)
αD=(5, 6, 8, 13, 17, 19, 22, 23, 35)
α²D=(3, 4, 11, 21, 25, 27, 28, 30, 36)
α³D=(2, 14, 15, 18, 20, 24, 29, 31, 32).

A similar construction to the one outlined above can be obtained by taking v=4r²+9 a prime and an odd integer.

### CONCLUSION

The invention provides a new approach for the analysis of DNA sequences, based on combinatorial-analytic concepts. In the invention, genomic sequences are represented by subsampled versions of the sequences derived from the distribution of difference sets. This representation is convenient for two primary reasons.

Difference sets capture the random character of genomic sequences. Hence sequence homology markers can be directly linked with sequence regions of high combinatorial complexity and, possibly, with regions that have a longer evolutionary history.

The analysis of DNA sequences can be replaced by the analysis of much shorter difference set sequences, thereby reducing the cost of computation.

Direct applications of the difference set approach are rapid sequence homology assessment and one-against-all database match search. To test the efficacy of the difference set approach in these applications experiments on closely related strains of the B. anthracis genome were performed. The results of these experiments include:
Characterization of the abundance of the (7, 3, 1) difference set in the B. anthracis genome,
Demonstration that the computational efficiency of the proposed approach exceeds that of the state-of-the-art methods, diffseq and BLAST, and
Discovery of collections of novel indels in B. anthracis plasmid and chromosomal sequences.

The first result shows that, apart from comparative in silico studies, difference sets can be used as increased resolution strain markers for an experimental assay-based identification of bacterial sequences. Current genotyping approaches in this category are limited, for the most part, to parsimonious assays that rely on a relatively small number of non-uniformly distributed VNTRs or SNPs. These assays can identify individual strains from a limited collection of fully sequenced, closely related genomes. However, they are not effective when only partial sequence data is available, the data contains sequencing errors, or the collection includes unknown strains. In these cases it is required that the bacterial genome space be sampled at multiple loci and with a greater degree of uniformity. As difference sets occur in bacterial genomes more frequently than either VNTRs or SNPs, a difference set-based strain fingerprinting scheme can address these issues more effectively.

While the importance of sequence homology assessment in comparative genomics is well recognized, it is useful to cast the task as an application of sequence complexity studies. These studies often link the concept of complexity with the concept of randomness. Addressing this broader application domain, the methods of the present invention show that no significant part of the DNA sequence can be considered algebraically random. Future research utilizing more advanced difference set constructions, such as almost difference set families, permit further quantification of this result in terms of degrees of randomness.

### Computer Implementation

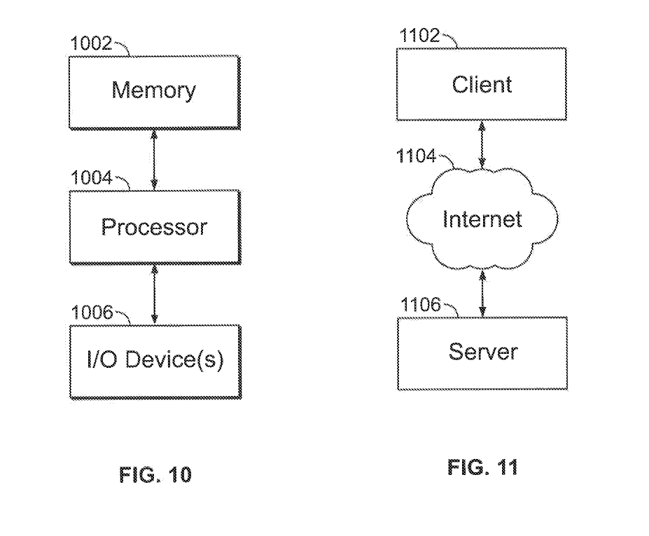

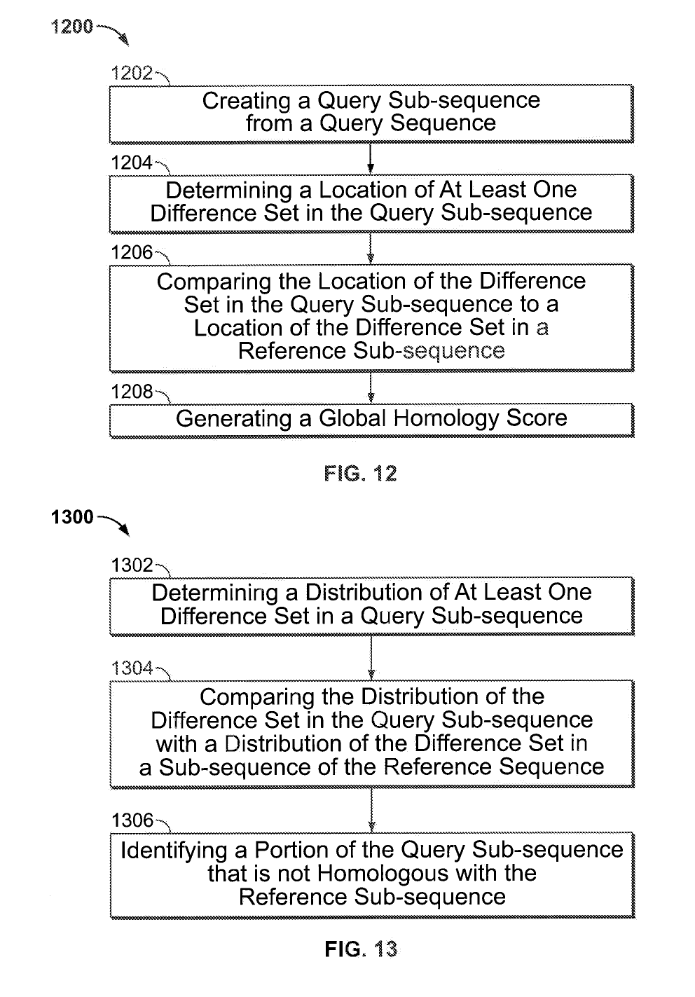

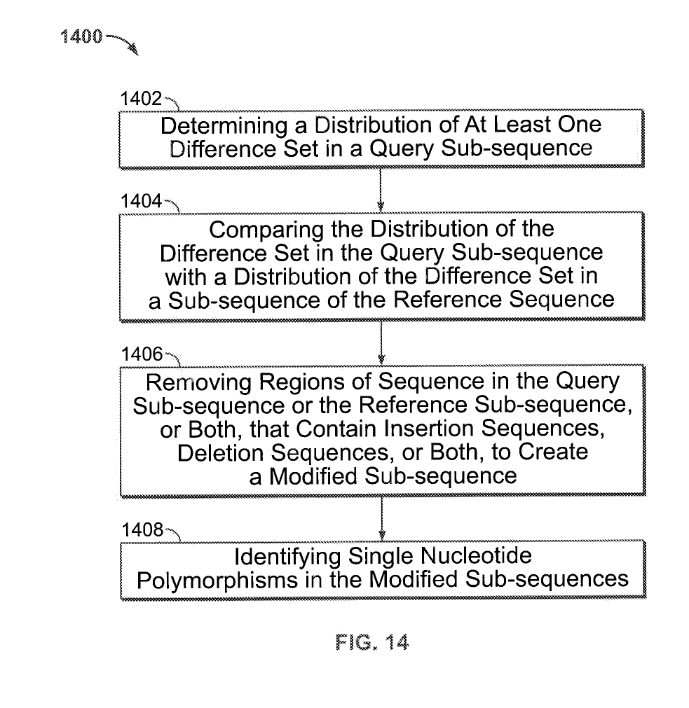

The methods of the invention are implemented using a computer. FIGS. 10 and 11 provide exemplary schematics of the hardware systems that can be used to implement the methods of the invention. FIG. 10 is a block diagram of an exemplary hardware implementation of the rapid genomic sequence assessment system methods of the invention. As shown, the system may be implemented in accordance with a processor 1004, a memory 1002 and I/O devices 1006. The term “processor” as used herein includes any processing device, such as, for example, one that includes a CPU (central processing unit). The term “memory” as used herein includes memory associated with a processor or CPU, such as, for example, RAM, ROM, a secondary or fixed memory device (e.g., hard drive), a removable memory device (e.g., diskette, CD, DVD), flash memory, memory stick, etc. In addition, the term “input/output devices” or “I/O devices” as used herein includes, for example, one or more input devices, e.g., keyboard, for making queries and/or inputting data to the processing unit, and/or one or more output devices, e.g., CRT display and/or printer, for presenting query results and/or other results associated with the processing unit. The term “processor” may refer to more than one processing device and that various elements associated with a processing device may be shared by other processing devices. Accordingly, software components including instructions or code for performing the methodologies of the invention, as described herein, may be stored in one or more of the associated memory devices (e.g., ROM, fixed or removable memory) and, when ready to be utilized, loaded in part or in whole (e.g., into RAM) and executed by a CPU.

FIG. 11 is a block diagram of a network-based implementation of the rapid genomic sequence assessment system of the present invention. As shown, a client computer system 1102 is in communication with a server computer system 1106 via a wired and/or wireless network 1104 such as, for example, the internet. However, the network could also be a private network and/or a local network. According to the implementation of FIG. 11, all or a portion of the elements of the system of the invention reside on and are executed by the server 1106. A user operating remotely on his client computer system, e.g., a personal computer, laptop and/or some other type of personal processing device, enters a query sequence through application software running on the computer system, e.g., web browsing software and/or a graphical user interface associated with the search engine. The query is passed over the network 1104, in a conventional manner, and processed by server 1106. The server 1106 receives the query and executes the methodologies of the present invention.

In this document, the terms “computer program medium” and “computer usable medium” are used to generally refer to media such as any data processing memory or storage device or module described herein, or otherwise existing or developed in the future. Signals carried over a network or communications path can also embody the logic described herein. Computer program medium and computer usable medium can also refer to memories, such as main memory and secondary memory, which can be memory semiconductors (e.g. DRAMs, etc.). These computer program products are means for providing software to a computer system.

Computer programs (also called computer control logic) are stored in main memory and/or secondary memory. Computer programs may also be received via a communications interface. Such computer programs, when executed, enable a computer system to implement the present invention as discussed herein. In particular, the computer programs, when executed, enable processor(s) to implement the processes of the present invention.

### EXAMPLES

### Example 1

### Sequence Homology Assessment

### Sequence Homology Assessment Algorithm

The abundance and similarity of distributions of difference sets in B. anthracis plasmids is shown in this example. Since distributions of difference sets are significantly shorter than DNA sequences, similarity of the distributions can be assessed faster than similarity of the DNA sequences. Coupling this procedure with the Fourier space cross-correlation method further enhances the speed advantage.

The main step in the design of the difference set-based procedure for assessing DNA sequence homology is the construction of a compact representation of the difference set distribution. This step can be implemented in several ways. The following example illustrates the simplest, but not necessarily the most efficient, of these implementations.

DNA subsequences associated with one of the four nucleotides were compared. Results of the four binary analyses were combined by summing the four individual correlation sequences. Denote by α and β the selected binary subsequences associated with the DNA sequences to be assessed, by α_{D} and β_{D} the difference set distributions, and by x and y the corresponding compactified difference set sequences. Denote by N and n the lengths of the DNA and the compacted difference set sequences, respectively, and by the order of the additive group of integers, G, that determine the length of the difference set. The assessment of homology between α and β can then be accomplished by the following two-stage procedure.

### Algorithm

In the first stage of the algorithm, difference set distributions were used to evaluate rough sequence homology in a barcode matching fashion. Individual tasks follow.

Compute the difference set distribution of the DNA sequence under consideration, α,

$${α}_{D} = {\sum }_{l ∈ D} {α}_{k + l} + {\sum }_{l ∉ D} {\overline{α}}_{k + l} , \\ 1 \leq k < N - v$$

where ā=α+1 (mod 2). In a similar manner compute β_{D}. This task requires vN real additions per sequence.

Convert the N-point difference set distribution sequences, α_{D} and β_{D}, to shorter, n-point sequences of gaps between subsequent locations of difference sets (i.e., the difference set sequences), x and y.

Compute the phase-only cross-correlation of the difference set sequences,

$${DFT}^{- 1} \{ \frac{x ( k ) \overline{y} ( k )}{\vert x ( k ) \overline{y} ( k ) \vert} \} , \\ x ( k ) and \overline{y} ( k ) \neq 0$$

where x and y denote the DFTs of x and y, respectively. This task requires 3n log n+2n complex multiplications.

Use the dominant values of the cross-correlation sequence (as explained in Section III) to identify homologous and nonhomologous blocks of the original DNA sequences. For example, suppose that the dominant value of the cross-correlation sequence occurs at and set

yₛ=[yₛ, yₛ₊₁, . . . , yₛ₋₁, y₀, . . . , yₛ₋₁].

Then a homologous segment is given by the non-zero values of the vector expressed in Matlab as

x.*[x==yₛ].|

This task requires pn real multiplications, where p is the number of dominant values in the cross-correlation sequence (p=1 when sequences are identical).

In the second stage of the algorithm, non-homologous blocks whose boundaries coincide with appropriate difference sets are individually aligned to reveal fine differences between genomes.

Characterization of Indels in B. anthracia pXO1 Plasmid and Chromosomal Sequences

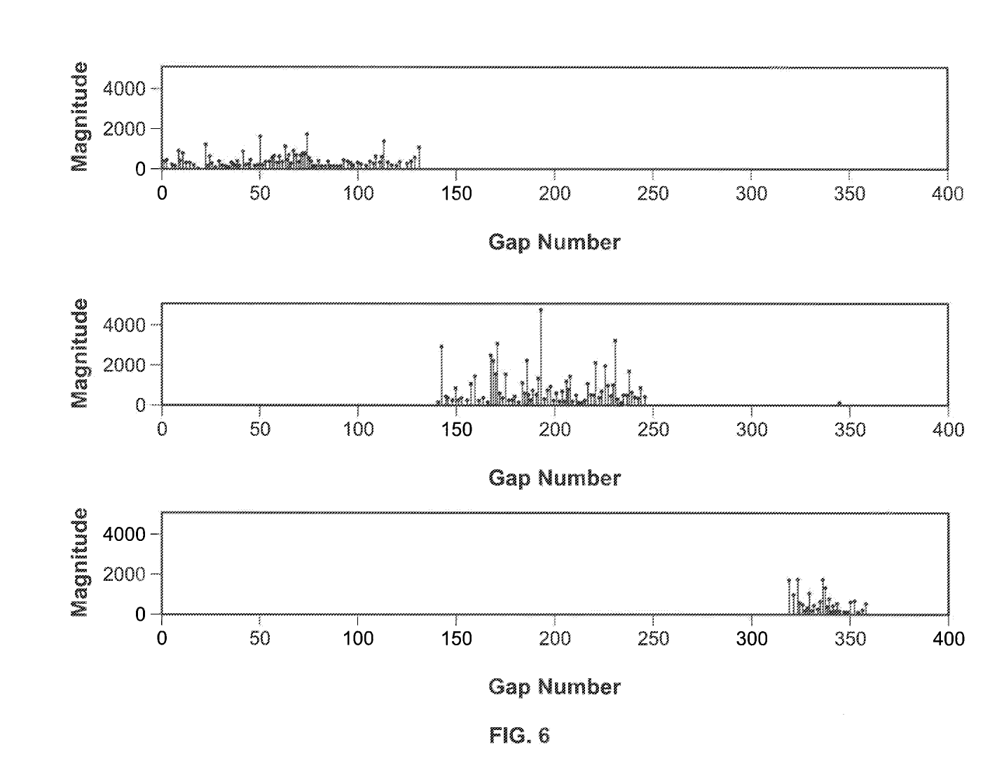

To evaluate the efficacy of the difference set homology assessment approach, first the two pXO1 plasmids described in previous section are compared. Here, the relevant sequence lengths are N1=181677 and N2=181654, respectively, and n=397. As in the previous experiment, the (7, 3, 1) difference set was chosen for the analysis. Results of individual computations of the first stage of the algorithm are shown in FIG. 4 (step 1), FIG. 5 (steps 2 and 3) and FIG. 6 (step 4). As the compressed difference set sequences in FIGS. 5 and 6 denote gap lengths rather than difference set locations, only a rough visual comparison between the plots in FIGS. 4 and 5 can be made.

The first step of the algorithm requires the computation of the difference set distributions α_{D} and β_{D}. These distributions are shown in FIG. 4: the sequence of the Ames Ancestor plasmid (upper plot) and the sequence of the Sterne plasmid (lower plot). The distributions are obtained by a running window analysis of binary sequences associated with the nucleotide C, as described in step 1 of the algorithm.

In the second step of the algorithm the N-point distributions of difference sets are converted to shorter, n-point sequences x and y of inter-difference set gap lengths. These sequences are shown in the two top plots of FIG. 5. This step is followed by computation of the Fourier space phase-only cross-correlation between the two sequences. The latter computation is the most costly part of the algorithm, with multiplicative complexity of the order of n′ log n′, where n′=(step 3) The result of this computation is shown in the bottom plot of FIG. 5. While the transformation of difference set locations to gaps is an information-preserving operation, manipulation of information in the “gap” space can be more difficult than in the original space. For example, direct application of correlation to gap sequences emphasizes isolated difference set matches over those that are closely spaced. This effect is undesirable, as it may lead to magnification of correlation sidelobes and the appearance of false alignments. The problem can be addressed by replacing the decimal integer numbers in the n-point gap sequences with b digit-long binary numbers and by concatenating these numbers to form bn-point binary sequences. The cost of this operation is an increase in the gap sequence length by a factor of b, and a corresponding increase in the computational complexity of the correlation. This increase can be mitigated by employing a “lossy” decimal-to-binary conversion that retains only the lower order bits of the binary number. While in the B. anthraces experiment a modestly conservative value of b=5 was used, values as small as 2 produced satisfactory results. In an alternative approach, an ideal correlation sequence can be obtained by operating on the original n-point gap sequences if the correlation values are fixed as the numbers of matching gaps in the appropriately shifted sequences. The disadvantage of this approach is that it cannot be easily implemented in the Fourier domain.

The plot reveals three greater than 0.23 peaks at locations 0, 3, and 36. The correlation threshold was set to μ+3σ, where μ and σ denote mean and standard deviation of the correlation sequence, respectively. These peaks reveal the presence of three matching (S₁, S₂, and S₃) and two mismatching (I₁ and I₂) segments in the difference set sequences. These segments can be identified by comparing the first difference set sequence with the appropriately shifted second difference set sequence (step 4). The result of this operation is shown in FIG. 6. A rough pictorial representation of segment decomposition of the two sequences is given by the graph

| . . . S₁^{A} . . . | . . . I₁^{A} . . . | . . . S₂^{A} . . . | . . . I₂^{A} . . . | . . . S₃^{A} . . . |

| . . . S₁^{S} . . . | . . . I₁^{S} . . . | . . . S₂^{S} . . . | . . . I₂^{S} . . . | . . . S₃^{S} . . . |

where the superscript denotes either Ames Ancestor or Sterne sequence. Note that the length of a segment of difference set distribution is determined by the number of difference sets it contains, not by the number of bps.

Accordingly,

S₁^{A}≈S₁^{S}, 1≦i≦3

and

Iᵢ^{A}≠Iᵢ^{S}, 1≦i≦2.

In subsequent analysis, for brevity, the superscripts are ignored when the identity of the sequence in question will be apparent.

The segment decomposition of the plasmid sequences can be further quantified.

The first two segments S₁ and S₂ are separated by a relatively short mismatching sequence of seven difference sets (indices 133-139). This sequence corresponds to the mismatching segment I₁ located between 43 275-49 509 bp in the Ames Ancestor DNA sequence. This segment contains the insertion segment I₁-139 located at 43 348-48589 bp. The structure of the large insertion segment I₁-439 can be further refined: allowing for the occurrence of additional three indels and 21 SNPs in the matching segments S₁ and S₂ places the insertion segment I₁ at the increased resolution positions of 43 34848 589 bp (Ames Ancestor coordinates) and 43 297-48 539 bp (Sterne coordinates).

TABLE I
List of PXO1 INDELS.

| PM ID | | | | |
|---|---|---|---|---|
| & cds | CDs pairs | Length | | |
| indices | coordinates | difference | PM type | PM position |
| | | Small | | |
| | | indels | | |
| S₁-3 | 874-1480 | +135 | Insertion | 1171-1305 |
| | 874-1345 | | segment | 1170+ |
| S₁-20 | 5540-6024 | −1 | 0→T | 5747+ |
| | 5405-5890 | | | 5613 |
| S₁-77 | 29271-29701 | −85 | Insertion | 29345+ |
| | 29137-29652 | | segment | 29212-29296 |
| S₁-90 | 31187-32091 | +1 | G→0 | 31708 |
| | 31138-32041 | | | 31658+ |
| S₁-103 | 34146-34814 | +1 | T→0 | 34633 |
| | 34366-34763 | | | 34582+ |
| S₂-194 | 85894-86533 | −1 | 0→T | 86321+ |
| | 85843-86483 | | | 86271 |
| S₂-203 | 89614-90013 | +1 | 0→A | 89638+ |
| | 89564-89962 | | | 89587 |
| S₂-205 | 90674-90972 | +1 | A→0 | 90813 |
| | 90623-90920 | | | 90761+ |
| S₂-218 | 96976-97762 | −1 | 0→A | 97387+ |
| | 96924-97711 | | | 97336 |
| S₂-247 | 116406-116958 | −1 | 0→A | 116949+ |
| | | | | 116899 |
| S₂-321 | 163762-164923 | −1 | 0→A | 164547+ |
| | 163718-164880 | | | 164504 |
| S₂-336 | 172059-172746 | −20 | Insertion | 172236++ |
| | 172016-172723 | | segment | 172194-172213 |
| | | Large | | |
| | | indels | | |
| I₁-139 | 43275-49509 | 0 | Insertion | 43348-48589 |
| 133-139 | 43224-49458 | | segment | 43298-48539 |
| I₂-319 | 117018-162069 | +6 | Insertion | 117228-162050 |
| 249-319 | 116968-162025 | | segment | 117178-162006 |

PM S₁-3 denotes the insertion polymorphism contained in the matching segment S and ending in the Ames ancestor sequence with the difference set 139.
PM I₁-139 denotes the insertion polymorphism contained in the insertion segment I and ending in the Ames ancestor sequence with the difference set 139. the same naming convention is followed for all polymorphisms.
For the large inter-segment insertions, I₁-139 and I₂-319, the range of relevant difference sets is specified in column 1.
Values given in columns 2, 3, and 5 refer to BP numbers.
Top and bottom values in column 2 denote boundaries of difference set sections of Ames ancestor and Sterne sequences, respectively.
The number in column 3 is the difference between relevant difference set section lengths of Ames ancestor and Sterne sequences.
The sign ‘+’ in column 5 indicates a single base gap following the specified position.
the sign ‘++’ in column 5 additionally denotes that while the insertion sequence has length 21, one of the bases has a matching base in the Ames ancestor sequence (and hence the difference between the sections in column 3 is only 20).
The expression 0 → T denotes deletion of base T in the first sequence.
insertion s₁-336 contains VNTR ‘AAAATAAATATATAATAGTT’.
insertion I₂-319 contains VNTR ‘TTA’.

The second and third segments S₁ and S₂ are separated by a much longer mismatching sequence of 71 difference sets (in-dices 249319). This sequence corresponds to the mismatching segment located between 117 018162 069 bp in the Ames Ancestor DNA sequence. This segment contains the insertion segment I₂-319 located at 117 228162050 bp (see Table I, for details).

While the first stage of the algorithm permits rough alignment of the plasmid sequences, including the determination of matching segments and large insertion segments, the second stage permits the determination of the fine structure of indels. This is accomplished by identification of zeroes in the segments of FIG. 6. The occurrence of zeroes (within matching segments) is a consequence of differences in lengths of associated sections of DNA sequences, which, in turn, are due to the occurrence of indels. There are five such zeroes in segment S₁, five in segment S₂, and two in segment S₃ (see Table I). For example, the first zero occurs at the beginning of segment S₁ (index 3). Mapping the difference set zero index to DNA sequence coordinates reveals the 607 bp Ames Ancestor section located at 874-1480 bp and the 472 bp Sterne section located at 874-1345 bp. The difference in section lengths is due to the 135 bp long insertion sequence S₁-3 located at 1174-1308 bp (in Ames Ancestor coordinates).

TABLE II
List of chromosomal indels. A reduced naming convention was
used, where only position of the relevant difference set is
identified; the four i-4431 indels that occur within the same
difference set segment are distinguished by the number in the
suffix. The Indel i-4431-3 consists of a 10 BP insertion string in
the Ames ancestor chromosome and an 8 BP insertion string in
the Ames chromosome.

| PM ID & | Cds | Length | | |
|---|---|---|---|---|
| cds index | pair coordinates | difference | PM type | PM position |
| i-1247 | 677836-678586 | +1 | T→0 | 677964 |
| | 677836-678586 | | | 677963+ |
| i-1823 | 1012988-1013727 | −1 | 0→G | 1013546+ |
| | 1012988-1013727 | | | 1013546 |
| i-2069 | 1151217-1151409 | +122 | Insertion | 1151242-1151363 |
| | 1151217-1151287 | | segment | 1151241+ |
| i-2212 | 1237741-1239504 | +1 | A→0 | 1238367 |
| | 1237619-1239381 | | | 1238244+ |
| i-3251 | 1902486-2612131 | +1 | C→0 | 1902486 |
| | 2610722-2612002 | | | 1902362+ |
| i-4431-1 | 2610846-2612131 | +1 | C→0 | 2611984 |
| | 2610722-2612002 | | | 2611859+ |
| i-4431-2 | | +1 | A→0 | 2612020 |
| | | | | 2611984+ |
| i-4431-3 | | +2 | Insertion | 2612043-2612053 |
| | | | segment | 2611917-2611925 |
| i-4431-4 | | +1 | A→0 | 2612077 |
| | | | | 2611948+ |
| i-4599 | 2654926-2655426 | −1 | 0 →A | 2655134+ |
| | 2654797-2655298 | | | 2655006 |
| i-6001 | 3129615-3130279 | −1 | 0 →C | 3130114+ |
| | 3129487-3130152 | | | 3129987 |
| i-10598 | 4650825-4651248 | −1 | 0 →T | 4651190+ |
| | 4650698-4651122 | | | 4651064 |

Alignment of DNA sections corresponding to all relevant difference set pairs reveals three relatively large insertion sequences of lengths 135, 85 and 21 bps, and nine single base indels. The three large insertion sequences (−3, −77 and −336) have been reported previously (referred to therein as IX1-2, IX1-1 and VX1-3, respectively); the discovery of the nine single base indels −20, −90, −103, −194, −203, −205, −218, −247, and −321 is a new result.

To test the efficacy of the difference set approach on genome-length sequences, the homology assessment algorithm is applied to the chromosomal sequence of Ames Ancestor (AE017334) and Ames (AE016879), of lengths N₁=5227419 and N₂=5227293, respectively. As before, the analysis is performed using the difference set (7,3,1) and the nucleotide subsequence “C”. 12 354 of these difference sets were identified in the Ames Ancestor sequence and 12 353 in the Ames sequence. Although the chromosomal sequences are almost thirty times longer than the pXO1 plasmids, they are more homologous than plasmids and therefore they contain only twelve indels (see Table II, for details). The discovery of the twelve indels is a new result. It is noted that a single indel at an unspecified position was previously reported.

For completeness, similar analysis was performed on the pXO2 sequences. Excluding mismatching flanking sequences, the difference set analysis revealed seventeen indels (see Table III for details).

### Global Homology Assessment

Above, indels of two closely related B. anthracia strains were characterized. Here, these findings are summarized by computing a global homology score. This score is a ratio of the number of nucleotides identical in the two sequences and the total number of nucleotides in one of the sequences. As sequence lengths slightly differ, two scores are generated in each case. Denote by AA,A and Sthe Ames Ancestor, Ames and Sterne strains, respectively. Moreover, denote by p and c the plasmid pXO1 and the chromosomal sequence. Addition of relevant indels from Tables I and II yields the homology scores and

$$hom ( {p}_{AA} \cdot {p}_{S} ) = \frac{131474}{181654} \approx 0.7237$$

$$hom ( {p}_{S} \cdot {p}_{AA} ) = \frac{131474}{18677} \approx 0.7238$$

$$and$$

$$\begin{matrix}hom ( {c}_{AA} \cdot {c}_{A} ) = \frac{5227289}{5277293} = 1 - 0.76 \times {10}^{- 6} \\ hom ( {c}_{A} , {c}_{AA} ) = \frac{5227289}{5277419} = 1 - 0.25 \times {10}^{- 4}\end{matrix} \vert$$

It follows that the pXO1 plasmid sequences are about 72% identical and the chromosomal sequences are almost 100% identical. While in both cases sequences contain multiple indels (14 and 12, respectively), also in both cases most of the genomic difference is concentrated in two large insertion segments (I₁-139 and I₂-319 in plasmids and i-2069 and i-4431-3 in chromosomes). Apart from the flanking sequences, the pXO2 plasmids contain only small indels and hence they are nearly 100% identical.

TABLE III
LIST OF PXO2 INDELS
As in Table 2, a reduced naming convention was used. All eleven
single base indels are due to single base VNTRs, except for i-61,
which is due to the VNTR of the string TCA

| PM ID & | cds pair | Length | | |
|---|---|---|---|---|
| cds index | coordinates | difference | PM type | PM position |
| i-1 | 1-98 | −493 | Insertion | +1 |
| | 1-592 | | segment | 1-493 |
| i-40 | 10999-11253 | +1 | T→0 | 11103 |
| | 11493-11746 | | | 11596+ |
| i-61 | 17922-18668 | +1 | T→0 | 17975-18467 |
| | 18415-19160 | | | |
| i-78 | 22133-23127 | +1 | T→0 | 22413-22905 |
| | 22625-23618 | | | |
| i-83 | 23989-24216 | −1 | G→ 0 | 24150-24641 |
| | 24480-24706 | | | |
| i-97 | 28582-29203 | +1 | 0 → T | 28984-29474 |
| | 29072-29694 | | | |
| i-102 | 30580-30882 | +1 | T→0 | 30832 |
| | 31071-31372 | | | 31323+ |
| i-122 | 35445-35883 | −8 | Insertion | 35828+36318-36325 |
| | 35935-36381 | | segment | |
| i-152 | 47851-49218 | +8 | Insertion | 48103-48110+ |
| | 48349-49708 | | segment | 48597+ |
| i-187 | 57893-58601 | +5 | Insertion | 58394-58398 |
| | 58383-59086 | | segment | 58883+ |
| i-192 | 60277-60701 | +12 | Insertion | 60361-60372 |
| | 60762-61174 | | segment | 60845+ |
| i-194 | 61006-61391 | +1 | T→0 | 61196 |
| | 61479-61863 | | | 61669+ |
| i-199 | 63441-63751 | +1 | A→0 | 63574 |
| | 63913-64222 | | | 64046+ |
| i-203 | 64842-65124 | +1 | C→0 | 64859 |
| | 65313-65594 | | | 65330+ |
| i-207 | 66616-67036 | −1 | 0→T | 67019+ |
| | 67086-67507 | | | 67489 |
| i-212 | 67774-68640 | +1 | A→0 | 67984 |
| | 68245-69110 | | | 68455+ |
| i-216 | 71812-73040 | −8 | Insertion | 73018+ |
| | | | segment | 73488-73495 |
| i-224 | 74970-75188 | +4 | Insertion | 75035-75038 |
| | 75448-75622 | | segment | 75513+ |
| i-295 | 94040 | −927 | Insertion | 94830+ |
| | 94514-95402 | | segment | 95305-96132 |

### Example 2

### Comparison of the Results in Example 1 with Benchmarks

In Example 1, a novel algorithm for efficient identification of matching and mismatching regions of highly homologous DNA sequences was described. In this example, the performance of this algorithm with that of the state-of-the-art methods were compared. Surprisingly, few techniques have been designed to address this problem directly. Most DNA sequence alignment methods such as BLAST, MuMmer and PatternHunter, are not well suited to this task: they produce large lists of overlapping alignments that difficult to disambiguate, rather than enumeration of unique genomic differences. The only generally available method we were able to identify that targets the same application as the difference set approach is the diffseq code of the EMBOSS suit of sequence analysis tools.

The performance of the diffseq and difference set methods using the pXO1 plasmids (181654 bp) and the chromosomal sequences (5 227 293 bp) of two strains of the B. anthracis genome were compared. Experiments were performed on 2.13 GHz Pentium PC with 1 GB of memory, running Microsoft Windows XP. Diffseq was run as part of the latest version of the EMBOSS suite, downloaded from the EMBI website on Mar. 15, 2009. The difference set algorithm was run in MATLAB 7.0.1 (R14). Diffseq and the difference set approach produced identical lists of indels. However, diffseq required 5 seconds to process the plasmid sequences and it ran out of memory while processing the chromosomal sequences. In contrast, the difference set algorithm required 0.09 seconds to process the plasmid sequences and 1.83 seconds to process the chromosomal sequences. Apart from differences in processing speed, these results suggest that the memory space required by diffseq, while difficult to estimate due to the hash table method used, is significantly larger than that needed for the difference set approach. In Example 1, the difference set algorithm required storage of both DNA sequences; this space requirement can be easily reduced by a factor of about 500, as the core computation is performed on much shorter difference set sequences.

As noted previously, sequence alignment methods target a distinct set of applications. However, since the difference set-based homology assessment is closely coupled with the phase-only Fourier space sequence alignment technique (referred to in the art as the symmetric phase-only matched filter, or SPOMF), it is appropriate to consider the relative merits of the difference set approach, SPOMF and the most popular sequence alignment tool, BLAST. A detailed comparison of SPOMF and BLAST (the fast MegaBLAST version) was given previously. Here, a brief summary is given.

SPOMF consistently outperforms BLAST in alignment runtime for sequence sizes greater than 10⁶ bp, which is far less than the size of any reasonable sequence database (the NCBI Gen-Bank total sequence size exceeds 10¹¹ bp). Apart from delivering higher computational efficiency, SPOMF overcomes several other deficiencies of BLAST, including its data-dependent run-time, lack of a multiscale processing stage, and a high degree of parameterization that is not readily transparent to the user.

While the difference set approach relies on SPOMF to speed up the computation of its main stage, it achieved a significant run-time reduction over the direct implementation of SPOMF by sub-sampling the DNA sequence space. In contrast to BLAST, which due to the heuristic nature of its core computations does not permit analytical complexity assessment, the computational advantage of difference sets over SPOMF can be easily quantified.

The overall multiplicative complexity of the difference set algorithm is

O_{DS}=n′(3 log₂n′+p+2).

The overall multiplicative complexity of the phase-only Fourier space cross-correlation method applied directly to DNA sequences is

O_{SPOMF}=N(3 log₂N+p+2).

The multiplicative complexity reduction achieved in the chromosomal sequence comparison is θ_{SPOMF}/θ_{DS}≦139. The corresponding multiplicative complexity reduction over an N² type method is 439 000.

### Example 3

### Detection of Single Nucleotide Polymorphisms in B. anthracis

Three strains of the B. anthracis genome were compared and previously unpublished single nucleotide polymorphisms (SNPs) were revealed. Moreover, it was discovered that, despite the highly monomorphic nature of B. anthracis, the SNPs are (1) abundant in the genome and (2) distributed relatively uniformly across the sequence.

The occurrence of SNPs was investigated in the three main strains of the B. anthracis genome: Ames Ancestor, Ames and Sterne. SNPs were shown to be abundant in the B. anthracis genome and that they were distributed relatively uniformly throughout the sequence. These findings demonstrated that the B. anthracis SNPs can be used effectively as part of an increased resolution, multi-tier strain differentiation scheme for the analysis of moderately incomplete, noisy or uncertain data. The SNP detection approach used here is based on an advanced design theory construction known as the cyclic difference set. In this approach the comparison of DNA sequences is replaced by the comparison of cyclic difference set distributions associated with these sequences. The similarity of these distributions is

The B. anthracis genome is made up of chromosomal DNA and two plasmids, pXO1 and pXO2. The chromosomal sequences of Ames Ancestor GenBank: NC_{—}007530.2, Ames GenBank: NC_{—}003997.3, and Sterne GenBank: NC_{—}005945.1, the pXO1 plasmid sequences of Ames Ancestor GenBank: NC_{—}003980 and Sterne GenBank: NC_{—}001496, and the pXO2 plasmid sequences of Ames Ancestor GenBank:

NC_{—}003981.1 and Pasteur GenBank: NC_{—}012659.1 were analyzed. The Ames Ancestor, Ames, Sterne, and Pasteur are referred as AA, A, S, and P.

The algorithm consisted of two main stages: indel detection and SNP detection. In the first stage the occurrences of certain short quasi-random strings, called cyclic difference sets (DSs), in two homologous DNA sequences were identified and, subsequently, the locations of these occurrences were compared. The rationale for using DSs as sequence markers is that when DNA sequences are highly homologous, so are the sequences of DS locations. Conversely, in regions where DNA sequences differ, so do the DS sequences. This is convenient as the analysis of DNA sequences can then be replaced by the analysis of much sparser, and therefore easier to compute, DS sequences. Since a difference in DS sequences marks the occurrence of an indel, mismatching segments were removed from the DS sequences. In the second stage, the DS sequences are mapped back to “new”, indel-free DNA sequences. These DNA sequences differ only by nucleotide mismatches. Once adjacent mismatches were filtered, SNPs were easily identified by a point-wise comparison of the modified nucleotide sequences.

### Results

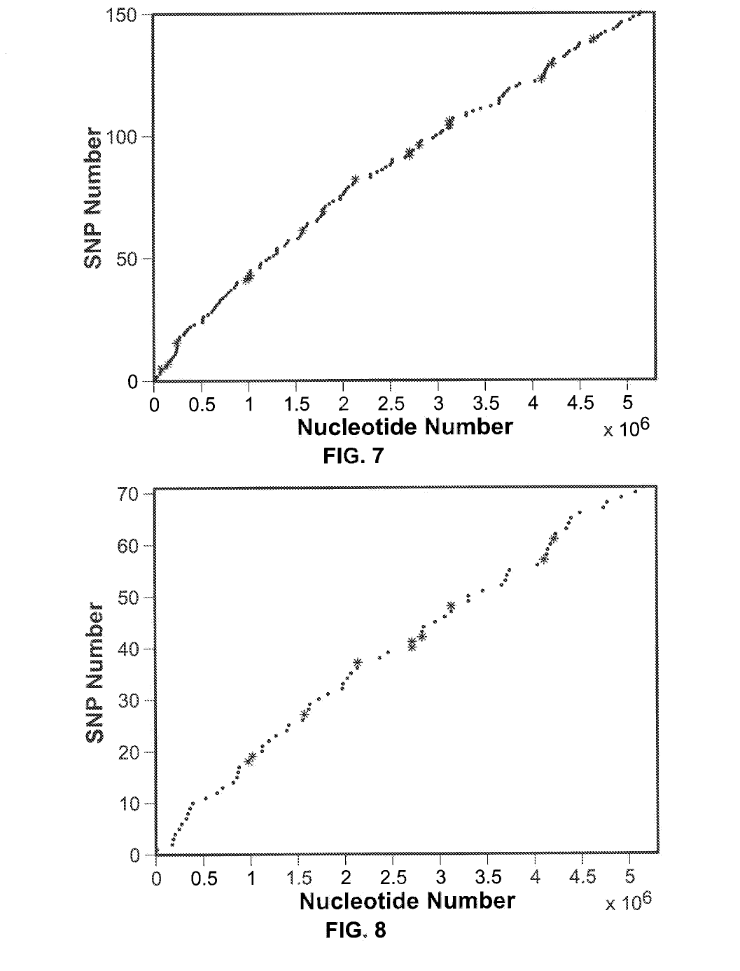

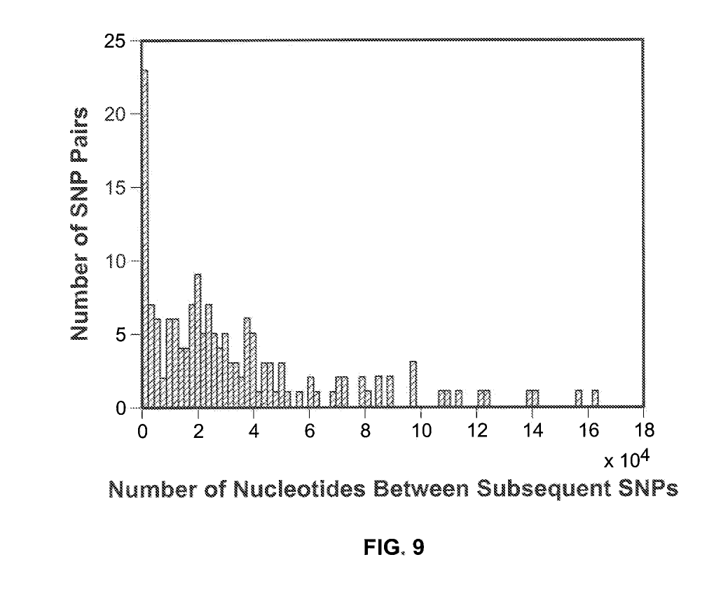

The results of the SNP analysis of the B. anthracia genome are summarized in Tables 4 and 5. The distributions of the chromosomal SNPs (all and non-synonymous) are shown in FIGS. 7 and 8. The histogram of distances between subsequent chromosomal SNPs is shown in FIG. 9.

The chromosomal analysis included the three pair-wise comparisons of AA-S, AA-A and A-S. These comparisons revealed 131, 19 and 150 SNPs, respectively (Table 4). The SNPs found in the AA-S and AA-A strain comparisons partition the SNPs found in the A-S strain comparison. The relatively large number of SNPs in AA-S confirms that AA is evolutionarily more distant from S than from A. About 70% of chromosomal SNPs are coding and about 80% of coding SNPs are non-synonymous. The ratio of all coding SNPs to all SNPs is 67%. This ratio is only modestly lower than the ratio of coding DNA and the entire genome sequence lengths, 78% in the AA strain. This result suggests that there is a similar degree of sequence conservation in the two sequence types. Both SNPs and nsSNPs are relatively uniformly distributed along the chromosome (FIGS. 7 and 8). The minimum, average and maximum distance between subsequent A-S SNPs is 2, 34499 and 163349 bp, respectively, although many SNPs are less than 2000 bp apart (FIG. 9, Table 5). The distributions of SNPs are only negligibly affected by the occurrence of indels. This is so because chromosomal sequences are highly homologous: the AA-A comparison yields only two multi-base indels, a 123-base-long indel at 1151242 bp and a 10-base-long indel at 2612043 bp; the AA-S comparison yields a single 100-base long indel at 4147353 bp (all locations are given in the AA coordinates).

TABLE 4
Abundance and taxonomy of SNPs in Ames Ancestor,
Ames and Sterne genomes reported in and computed
using the DS approach.

| sequence | Read | DS | coding | ns |
|---|---|---|---|---|
| Chromosome (AA-S) | — | 131 | 90 | 62 |
| Chromosome (AA-A) | 2 | 19 | 11 | 10 |
| Chromosome (A-S) | — | 150 | 101 | 78 |
| Chromosome (AA-A-S) | — | 150 | 101 | 78 |
| pXO1 (AA-S) | 15* | 14 | 7 | 6 |
| pXO2 (AA-P) | 21 | 21 | 16 | 9 |

Hyphens denote that results for a relevant strain comparison were not published.
Asterisk denotes that adjacent SNPs, not considered here, were reported (see the discussion of SNPs in Section 3).

TABLE 5
Distribution of SNPs in Ames Ancestor, Ames, and Sterne
genomes. The average SNP spacing, given in Kbp, is
computed by dividing the sequence length by the number of
SNPs. Non-indel SNP spacing is computed similarly, except
that the lengths of all indels and polymorphic regions (SNP
clusters, i.e. regions where average SNP spacing is greater
than one in every twenty bases) are subtracted from the
total sequence length.

| | | | SNP spacing |
|---|---|---|---|
| | Strain | SNP spacing | (adjusted for |
| Sequence | homology | (average) | indels) |
| Chromosome (AA-S) | 99.96% | 90 | 62 |
| Chromosome (AA-A) | 100.00% | 11 | 10 |
| Chromosome (A-S) | 99.94% | 101 | 78 |
| pXO1 (AA-S) | 72.38% | 7 | 6 |
| pXO1 (AA-P) | 98.49% | 16 | 9 |

The plasmid analysis included pair-wise comparisons of strains AA-S for pXO1 and AA-P for pXO2. Given their relatively short sequence lengths, the pXO1 and pXO2 plasmids are polymorphism-rich, containing 14 and 21 SNPs each, respectively. Of these SNPs, 7 and 16 are coding SNPs. Of the coding SNPs 6 and 9 are nsSNPs. The minimum, average and maximum distance between subsequent SNPs in the pXO1 plasmid are 3, 12977 and 84568 bp. The minimum, average and maximum distance between subsequent SNPs in the pXO2 plasmid are 94, 4516 and 13884 bp. The density of SNPs decreases in the pXO1 and pXO2 plasmids when indels are removed from the sequences (Table 5). The effect is most pronounced in the pXO1 sequence, due to the occurrence of two large indels at 43348-48589 and 117228-162050 bp.

Overall, when adjusted for indels, SNPs are distributed, rather surprisingly, in a relatively uniform fashion across the entire B. anthracis genome, but with varying inter-SNP spacing in each of the three sequences. As might be expected, the spacing increases proportionally to sequence length.

While B. anthracis strains can be identified using certain minimal sets of markers, such as the so-called canonical SNPs or special sets of VNTRs, such approaches are effective only when the strain is known and the data is perfect. This might not always be the case. Indeed, in many practical sequence analysis scenarios the data can be Large (whole genome), Uncertain (a new strain), Noisy (contaminated at the source, corrupted in the process of data collection, sequencing or sequence assembly, or purposefully engineered), or Incomplete (LUND. In these cases a minimum set of markers will not, in general, suffice to identify strains, and higher resolution approaches, relying on sequence over-sampling, must be employed.

The methods of the present invention regarding SNP detection and identification together with the prior work on DSs both inform the design and suggest a certain organization of these approaches (Table 6). As already mentioned, the most parsimonious and error-prone strategy for strain differentiating is based on canonical SNPs. One can improve the resolution of this scheme, at the cost of increasing its complexity, by extending the canonical SNP set to the set of all known standard genomic differences. Aided by the ten-fold increase in the sampling rate, this approach will be effective in the case of closely related strains whose sequence data is of moderate quality. Exceptionally complex tasks, such as detection of data manipulation or revelation of unknown distant strains, will require the use of even more dense, uniform and flexible sequence sampling schemes. One such scheme is offered by the DS-based sequence homology assessment procedure disclosed herein. In this approach the average marker spacing can be selected from the range of tens to tens of thousands of nucleotides.

TABLE 6
DNA sequence fingerprinting scheme choices for the
B. anthracis chromosomal sequence ordered in
terms of increasing sequence resolution.

| Marker | # of markers | detectable strains | data quality |
|---|---|---|---|
| Canonical SNPs | 13 | known | perfect |
| All SNPs + VNTRs | 150 + 15 | some unknown | moderate |
| CDSs | ~10,000 | many unknown | poor |
| Sequence alignment | ~5,300,000 | arbitrary | arbitrary |

### Conclusion

The findings support the proposition that SNPs, together with indels and variable number tandem repeats (VNTRs), can be used effectively not only for the differentiation of perfect strain data, but also for the comparison of moderately incomplete, noisy and, in some cases, unknown B. anthracis strains. In the case when the data is of still lower quality, a new DNA sequence fingerprinting approach based on recently introduced markers, called cyclic difference sets, can be used.

The results in this Example extend the analysis given in Read et al., Science 296:2028-2033 (2002) in both the number of SNPs identified and the information provided about their type and distribution. While a later work, Van Ert et al., PLoS ONE 5:1-10 (2007), slightly extends the results of Read et al., it does so only with respect to the 12 so-called canonical SNPs. Indels and SNPs capture all sequence differences in pan-genomes. Pan-genome is a superset of all the genes in all the strains of a species. More generally, pan-genome can be defined as a reference genome for a species plus the superset of all the genomic variants occurring in all the strains.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-based method of detecting homology between at least one reference sequence and at least one query sequence, the method comprising:
(a) creating at least one query sub-sequence from the query sequence;
(b) determining the locations of at least one difference set in the query sub-sequence;
(c) comparing the locations of the difference set in the query sub-sequence to locations of the difference set in a reference sub-sequence; and
(d) generating a global homology score, wherein the global homology score represents a degree of homology between the reference sequence and the query sequence,
wherein each of (a)-(d) is performed on a suitably programmed computer.

2. The method of claim 1, wherein the reference sequence and the query sequence each represents a DNA sequence.

3. The method of claim 1, wherein the reference sequence and the query sequence each represents an RNA sequence.

4. The method of claim 1, wherein the reference sequence and the query sequence each represents a polypeptide sequence.

5. The method of claim 1, wherein the generating a global homology score in (d) comprises creating a barcode representing the locations of the difference set in the reference sequence, creating a barcode representing the locations of the difference set in the query sequence, and comparing the barcodes.

6. The method of claim 1, wherein the difference set is selected from the group consisting of (7, 3, 1) difference set, (13, 4, 1) difference set, and (11, 5, 2) difference set.

7. The method of claim 6, wherein the difference set is the (7, 3, 1) difference set.

8. The method of claim 1, wherein the generating a global homology score in (d) comprises calculating a ratio of the number of identical nucleotides in the query sub-sequence and the reference sub-sequence to the total number of symbols in either the query sequence or the reference sequence.

9. A computer-based method of determining the presence of an insertion sequence, a deletion sequence, or a combination thereof, in at least one query sequence as compared to at least one reference sequence, comprising:
(a) determining a distribution of at least one difference set in a query sub-sequence;
(b) comparing the distribution of the difference set in the query sub-sequence with a distribution of the difference set in a sub-sequence of the reference sequence;
(c) identifying a portion of the query sub-sequence that is not homologous with the reference subsequence, wherein the non-homologous portion indicates the presence of an insertion sequence, a deletion sequence, or both,
wherein each of (a), (b) and (c) is performed on a suitably programmed computer.

10. The method of claim 9, wherein the reference sequence and the query sequence each represents a DNA sequence.

11. The method of claim 9, wherein the reference sequence and the query sequence each represents an RNA sequence.

12. The method of claim 9, wherein the reference sequence and the query sequence each represents a polypeptide sequence.

13. The method of claim 9, wherein the distribution of the difference set in the query sub-sequence and the distribution of the difference set in the reference sub-sequence is each represented by a barcode.

14. The method of claim 9, wherein the difference set is selected from the group consisting of (7, 3, 1) difference set, (13, 4, 1) difference set, and (11, 5, 2) difference set.

15. The method of claim 14, wherein the difference set is the (7, 3, 1) difference set.

16. A computer-based method of identifying at least one single nucleotide polymorphism in at least one query sequence as compared to at least one reference sequence, comprising:
(a) determining a distribution of at least one difference set in a query sub-sequence;
(b) comparing the distribution of the difference set in the query sub-sequence with a distribution of the difference set in a sub-sequence of the reference sequence;
(c) removing regions of sequence in the query sub-sequence or the reference sequence, or both, that contain insertion sequences, deletion sequences, or both, to create modified sub-sequences;
(d) identifying single nucleotide polymorphisms in the modified sub-sequences from (c);
wherein each of (a)-(d) is performed on a suitably programmed computer.

17. The method of claim 16, wherein the identifying in (c) comprises a point-wise comparison of the modified subsequences.

18. The method of claim 16, wherein the reference sequence and the query sequence each represents a DNA sequence.

19. The method of claim 16, wherein the reference sequence and the query sequence each represents RNA sequence.

20. The method of claim 16, wherein the reference sequence and the query sequence each represents a polypeptide sequence.

21. The method of claim 16, wherein the difference set is selected from the group consisting of (7, 3, 1) difference set, (13, 4, 1) difference set, and (11, 5, 2) difference set.


SEQUENCE LISTING (2 sequences)

SEQ ID NO: 1 - DNA, 13 bp, Artificial sequence
  Example sequence
aacagctgcagtt

SEQ ID NO: 2 - DNA, 20 bp, Artificial sequence
  Insertion s1-336 contains this VNTR
aaaataaatatataatagtt